(19) United States
(12) Patent Application Publication
(10) Pub. No.: US 2024/0350971 A1
(43) Pub. Date: Oct. 24, 2024

(54) METHODS FOR OPTIMIZING GAS AND FLUID PROCESSING

(71) Applicant: DEXPRO CORPORATION, Calgary (CA)

(72) Inventors: Derek Marshall, Calgary (CA); James Van der Lee, Calgary (CA); Vaughn Hansen, Calgary (CA); N. Wayne McKay, Calgary (CA); James Maddocks, Calgary (CA)

(21) Appl. No.: 18/636,712

(22) Filed: Apr. 16, 2024

Related U.S. Application Data
(60) Provisional application No. 63/460,158, filed on Apr. 18, 2023.

(51) Int. Cl. B01D 53/26; B01D 53/00

(52) U.S. Cl. CPC B01D 53/265; B01D 53/002; B01D 53/261; B01D 53/263; B01D 2252/2026; B01D 2257/80

(57) ABSTRACT

Methods are presented for improving the efficiency of gas and/or fluid processing. The methods are applicable to fluid streams which may contain gas, liquid, entrainments, and combinations thereof. Embodiments are provided where inefficiencies in existing, for example, dehydration and/or condensation circuits are analyzed and further operations are added or removed or existing operations are relocated and/or removed. Other synergistic combinations are disclosed. The methods are predicated upon synergized amalgamation to realize the benefits of blended processing.

### FIELD OF THE INVENTION

The present invention relates to enhancing gas and fluid processing. More particularly, the present invention relates to combining processing method unit operations with, as an example, a dehydration and/or condensation/conditioning process and optimized processing methods resulting therefrom for gas/fluid stream processing efficiency enhancement.

### BACKGROUND OF THE INVENTION

In the existing technologies used to, for example, remove water from acid gas streams, there is significant consumption of chemicals, solid adsorbent materials, natural gas and electricity due to process requirements. In addition, these technologies emit carbon dioxide to the atmosphere because of associated combustion as well as venting of atmospheric waste streams that are typically not economic to be recovered.

Dehydration is the process of removing water to minimize or prevent hydrate and free water formation. In an acid gas with a relatively high HAS concentration, sufficient water is typically removed during cooling between stages of conventional multi-stage compression through to dense phase (some pressure above the critical pressure of the fluid) such that a separate dehydration process is not required. As the CO₂ content of the acid gas increases, sufficient water removal through compression alone becomes less likely and a separate dehydration process is usually required.

Conventional means of gas dehydration are solid desiccant adsorption, liquid desiccant absorption, refrigeration, membrane separation, and dry gas stripping. The most commonly used methods are solid desiccant adsorption and liquid desiccant absorption.

Glycol dehydration, a liquid desiccant absorption process, is generally regarded as the favored operational and most economical for most applications. Such liquid desiccant dehydration processes have several drawbacks:
glycol losses in a high pressure CO₂ service can be significant;
excess oxygen, typically found in combustion-formed acid gases significantly increases corrosion and accelerates the degradation of the glycol at higher regeneration temperatures, necessitating the addition of continuous glycol reclamation;
dehydration equipment must be manufactured from high cost, corrosion resistant metals such as stainless steel to handle the acidic liquids produced.
Glycol is typically heated to 400° F. for regeneration resulting in vaporizing of water and venting to atmosphere of any other contaminants also absorbed by the glycol, such as volatile organic compounds (VOC's), typically benzene, toluene, ethyl benzene and xylene (BTEX) and any stripping gases. Control of these fugitive emissions generally requires the addition of costly vapour recovery equipment and introduces the potential for further oxygen contamination.

Utility requirements of such processes are high and include the fuel used for glycol regeneration and the power required to pump the glycol and operate the vapour recovery equipment.

Significant total carbon footprint is generated as a result of the manufacturing of the dehydration equipment, and the CO₂ produced from the utility demands of the system and of the formulation of the glycol used in the dehydration process.

Dehydration by refrigeration makes use of the reduced ability of the gas to hold water as the temperature is decreased. Temperature reduction can be achieved indirectly by heat exchange from external ‘refrigeration’ or other temperature reduction process, or directly by expansion of the gas itself. Direct expansion of the gas is either isentropic expansion such as in a turbo-expander or isenthalpic expansion, such as through a Joule-Thomson (JT) valve used in a conventional choke plant or through a gas compression refrigeration process. Installing a dedicated indirect refrigeration unit solely for the purpose of dehydration is typically cost prohibitive.

Both direct isenthalpic and isentropic refrigeration dehydration methods utilize an expansion device, a low temperature separator and at least one heat exchanger to recover as much energy from the process as possible. In their simplest form, the entirety of the gas is expanded, either isenthalpically or isentropically, from a higher pressure to a lower pressure, resulting in a fluid temperature low enough for water condensation to occur. The condensed water is removed from the process in a low temperature separator and the residual low temperature, substantially dry gas is used to pre-cool incoming fluid to improve the thermal efficiency of the process.

In the isentropic expansion case, expansion is accomplished with an expander and the work extracted by the expander is typically used to partially recompress the outlet dry gas. The choice of whether to use isentropic or isenthalpic expansion is dependent upon the amount of water removal required, and therefore the amount of temperature reduction required. Isentropic expansion can achieve lower temperatures. From a capital cost perspective, the isentropic process is significantly more costly, but the ability to recover work has an offsetting advantage. From an operation and maintenance perspective, the isenthalpic process has an advantage of being mechanically and operationally simple and suitable for most applications. The offsetting disadvantage of the isenthalpic process is the requirement to consume additional work through increased compression requirements.

The common drawback of any of the refrigeration dehydration processes is that most applications require the gas stream to be cooled to a temperature that is near or below the hydrate formation temperature (HFT) to achieve the desired level of dehydration. For reliable operation, continuous addition of a thermodynamic hydrate inhibitor, such as glycol or methanol, is usually required to lower the hydrate formation temperature. If desired, both glycol and methanol are recoverable but require a separate regeneration process complete with all of the issues discussed earlier under liquid desiccant dehydration. Often the choice is made to use methanol without recovery as methanol is relatively benign and has less impact on downstream processes than glycol.

In U.S. Pat. No. 8,702,843, issued Apr. 22, 2014, Mckay et al., provided an effective methodology to address acid gas dehydration as well as removal of hydrocarbons. In essence, the technology in this document provided a method for removing condensable components from a fluid containing said condensable components where a fluid mixture with a positive Joule-Thomson coefficient containing condensable components is provided as an initial feed stream.

The initial feed stream is treated to condense liquids there from and the liquids removed to form a gas stream. The gas stream is then compressed and cooled to form a high pressure stream.

A portion of the high pressure stream is expanded to form a cooled low pressure stream with mixing of the cooled low pressure stream with the initial feed stream to augment cooling and condensation of condensable components present in the initial feed stream.

Mckay et al., in U.S. Pat. No. 11,125,499, issued Sep. 21, 2021, builds further on the precursor patent, supra.

In this document, a method for controlling hydrate formation during condensing condensable compounds from a feed stream is taught.

A vapour feed stream containing acid gases, hydrocarbons and water is provided with the formation of a cooled liquid stream from the feed stream through a separator. Pressure is maintained below and temperature above the hydrate formation temperature of the compounds in the cooled liquid stream. The cooled stream is then heated with the feed stream in a gas-liquid heat exchanger to form a heated liquid stream. The pressure of the stream is then reduced without hydrate formation and vapour, condensed hydrocarbons and water are collected at the reduced pressure.

The flexibility in utility of the Mckay et al. documents has now been found to be useful as a general basis for integration into other process to either substantially improve performance of those processes, eliminate costly other unit operations, mitigate CO₂ emissions amongst a host of other favourable results. As will be delineated herein after, many of the elevated efficiencies also result in very positive appealing environmental aspects.

### SUMMARY OF THE INVENTION

One object of one embodiment of the present invention is to provide elegant amalgamation of unit operations and concomitant processing circuits for fluid processing. By way of example, embodiments will characterize acid gas dehydration and efficient coaction with existing methods to achieve dehydration which may otherwise be suboptimal.

In the broadest sense, that by amalgamating different processes in terms of specific unit operations and chemical, mechanical and thermal attributes thereof, one can achieve improved results not derivable from straightforward modelling or utilization of conventional placement and operation of unit operations inherent in the pre-amalgamated processes.

A foundation of the technology to be elucidated herein is predicated upon synergizing fluid processing circuits. This involves treating a feed stream in a first fluid processing circuit configured to dehydrate the feed stream. Pretreatment operations may be performed to condition the feed stream. Attributed or evolved chemical, mechanical and thermal attributes resulting from treating the feed stream may be collected in some embodiments. For synergizing, a second fluid processing circuit may be selected for synergized combination with the first fluid processing circuit. An analysis of at least one of the individual unit operations efficiency and circuit efficiency in the second fluid processing circuit may be conducted with utilization of at least one of the recovered attributes in a predetermined location in the second fluid processing circuit. The beneficial results entail selectively recovering components present in a feed stream to be treated in the second fluid processing circuit stream otherwise not recoverable in the absence of attribute utilization, optimizing individual unit operations efficiency in the second fluid processing circuit, complete second fluid processing circuit efficiency singly and combinations thereof. It is contemplated that additional circuits may be added, subdivided or employed as standby circuits having attributes, supra, for targeted use.

Modelling may be utilized for purposes of general analysis or to determine predicted parameters, volumes, flow rates, temperature, residency time inter alia. With amalgamation as noted above, overdriving and/or under driving the specific conventional modelled parameters in a modified process has been found to yield advantages not realizable by straightforward modelling. When used herein, overdriving and under driving is referencing exceeding or underutilizing the normal operating parameters or prescribed characteristic operating standards as prescribed by a model. In the vernacular, the prescribed characteristic operating standards are those normally associated with unit operations operated in a stand-alone or conventionally grouped manner as opposed to efficiency based amalgamation and unification as will be further delineated. With the technology herein, temperatures, pressures, flow rates, quiescence, quantities, duration etc. may be counter intuitively altered to achieve a desired result upstream and/or downstream of the overall process. Further still, unit operations may be singly or collectively removed permanently or temporarily to achieve a desired result otherwise unachievable absent overdriving/under driving or other unit operation manipulation.

As a corollary to the synergized fluid processing circuits, the scope of utility of modelling platforms is inherently broadened: the platform is useable to analyze new scenarios only created through implementation of the synergized circuits.

Those skilled in the art will appreciate that some efficiencies of some unit operations in either or both of the analyzed and modified circuits may be intentionally partially compromised in respect of efficiency to mitigate and/or eliminate unnecessary operations, thermal use, chemical use, process speed, inter alia.

As an example, one or a plurality of unit operations may be conducted at the expense of using additional energy or other aspects in a transitory manner to improve the overall, for example, downstream performance. Such compromising may induce improvements in the unit operations and allow, for example, condensation of materials not otherwise condensable using conventional techniques. Although seemingly counterproductive, the global goal in such modification is focussed on a more desirable longer term capex and/or opex reduction with concomitant footprint, environmental and other benefits. For clarity, it may, for example, be more effective to run certain operations iteratively as opposed to in bulk to provide a refined product stream desirable to allow for precise downstream process objectives unrealizable absent iteration. From a prima facie view this is deleterious from an OPEX standpoint, however the downstream objective would propitiate any perceived downside.

The method may include the step of removing one or more unit operations from an analyzed circuit as well as repositioning one or more pre-existing unit operations in an analyzed circuit.

As will be appreciated, with an analyzed process there is attributed equilibria. By modifications discussed herein, new process equilibria may be established creating benefits throughout a modified process such enhanced product yield, lower energy consumption, equipment resize or elimination and previously unattainable recovery or synthesis of desirable components.

Further, for efficiency, the method may involve the step of dividing at least one selected unit operation into a plurality of subdivided unit operations optionally with pulsing and/or sequencing said subdivided unit operations in a predetermined time sequence.

Advantageously, dynamic assessment of at least one of utilization and parameters of the selected unit operations may be affected during operation of the modified circuit. This may be automatic; the data collected may then be utilized for automatic modification of an underperforming unit operation or detected process anomalies in the modified circuit. Suitable devices to achieve data collection will be appreciated by those skilled in the art.

In connection with the above, it will be further appreciated by those skilled that the partially comprised efficiencies may be sequenced over a predetermined time in specific intervals similar to pulsing or switching. To this feature of the technology herein, selected unit operations, for example, thermal operations, may be oscillated or pulsed in a predetermined timeframe to allow for branching a single source with average values achieving a similar result to an “always on” scenario.

Another object of one embodiment of the present invention is to provide a method for optimizing an acid gas dehydration circuit, comprising:
analyzing the overall efficiencies of the unit operations in the circuit;
selecting unit operations complementary to the analyzed acid gas dehydration circuit;
determining at least one of location, duration and sequencing parameters of selected unit operations for implementation in the circuit;
implementing selected unit operations and the parameters in the analyzed circuit to provide a modified circuit; and
operating the modified circuit where at least one of the modified circuit and selected operations is optimized.

In accordance with another object of one embodiment of the present invention there is provided a dehydration process, comprising:
a cooling stream synthesis stage including:
   condensing liquids from an initial feed stream to form a gas stream;
   compressing and cooling the gas stream to form a high pressure stream;
   expanding at least a portion of the high pressure stream to form a cooled low pressure stream;
   mixing of the cooled low pressure stream with an initial feed stream to augment cooling and condensation of condensable components present in the initial feed stream;
a treatment stage including:
   contacting a stream to be dehydrated with a dehydration protocol having a specific sequence of unit operations;
   introducing a synthesized stream from the cooling stream synthesis stage at a predetermined location in the dehydration protocol for contact with the initial feed stream associated with the dehydration protocol; and
   reducing at least one of the number of unit operations, chemical use and consumption, equipment and size thereof and energy requirement relative to a treatment stage absent the use of the synthesized stream. In embodiments, the synthesized stream may be introduced before, during, after and combinations thereof ol onset of the dehydration protocol.

Depending upon the existing dehydration protocol, the methods herein may include the step of modifying the duration of treatment with the synthesized stream in the existing dehydration protocol.

Other modifications include the flexibility of varying the location of treatment the said synthesized stream within the dehydration protocol.

Further, sequencing contact of the synthesized stream with unit operations of the dehydration protocol may be employed.

As another advantage, the methods herein may utilize varying flow rate of the synthesized stream. It is also contemplated that the synthesized stream may take the form of liquid, aerosol, spray and any combination of these to control, enhance and/or mitigate process operation.

Depending upon the existing dehydration protocol, the same may be improved using the methods herein by dividing unit operations of the dehydration protocol into a plurality of unit operations. By way of example, a mole sieve protocol may be split into a plurality of sub operations for multiple contact cycles with the synthesized stream. It will be appreciated by those skilled in the art that any of the existing unit operations in the dehydration protocol to which the cooled synthesized stream is exposed may be subdivided for improved performance.

In method variations, modulation may occur in at least one of the streams for contact with a stream being processed in the dehydration protocol through residency duration, recirculation, quiescence, turbulent flow, counter current flow, aerosol synthesis of the at least one of the streams, spray synthesis of the at least one of the streams and combinations of a plurality thereof.

To this end, the amalgamation methods herein permit optimization to a wide variety of fluid processing schemes. As a possibility, spray injection may be inserted into a tower to replace trays. The arrangement may alternate with trays and spray in a predetermined sequence.

Further, the methodologies herein would permit glycol circulation through a tower to maintain glycol volume up in the tower while keeping the regeneration volume low only requiring the addition/removal a small slip stream to the tower. It is believed that using cold glycol process conditions would result favourably.

In some embodiments, a normal or deep tray (or structured packing) may be used on the top of the tower and the new lean stream of glycol used to ensure dry gas exiting the tower. In this manner, operation would act like a glycol wash to capture any glycol aerosols created by spraying lower in the tower.

Another object of one embodiment of the present invention is to provide a method for processing raw natural gas, comprising:
treating the natural gas with a first process producing chemical, mechanical and thermal attributes;
providing a second process composed of a sequence of unit operations for treating a stream generated from the first process;
determining the efficiency of at least one of the unit operations;
utilizing at least one of the attributes to augment the determined efficiency of the at least one of the unit operations forming a modified second process; and
feeding the stream generated from the first process as a leed stream to the modified second process, whereby natural gas processed from the modified second process is refined.

The chemical attribute may comprise at least one of condensed compounds from the raw natural gas, water, propane, ethane, acid and combinations thereof. By way of example, recycling cooled regeneration gas to an upstream lower pressure stage of compression would eliminate the need for a regeneration gas separator.

Further, recycling dense phase CO₂ and injecting it ahead of a mechanical refrigeration system may be used to condense CO₂ to reduce the refrigeration horsepower load and equipment sizes.

Another example of utilizing a chemical attribute for enhanced efficiency can be realized by using a cooled recycled slipstream to cool suction streams entering the acid gas compressor stages, thereby improving the compressor efficiency.

The mechanical attribute may comprise at least one of positive pressure and negative pressure.

The thermal attribute may comprise at least one of partial cooling, partial heating, heat exchange and combinations thereof.

The method may further include further including at least one of the following steps:
rearranging the sequence of the unit operations;
removing at least one of the unit operations;
subdividing at least one of the unit operations into a plurality of divided unit operations;
operating selected unit operations serially, in parallel and combinations thereof;
varying at least one of rate, duration, recirculation and combinations thereof of a stream being processed;
inducing laminar flow, turbulent flow and combinations thereof of a stream being processed in predetermined areas of the first process and/or said second process;
inducing quiescent, pulsed, continuous and combinations thereof a stream being processed in predetermined areas of the first process and/or the second process; and
any combination of the aforementioned.

Either one or both of the first process and the second process may be a dehydration process. Preconditioning of a feed stream to be treated may be conducted as a preliminary step if required or desirable.

The dehydration process may be selected from solid desiccant adsorption, liquid desiccant absorption, refrigeration, membrane separation, dry gas stripping and combinations thereof.

As a convenient benefit of practicing the methods herein, compressor discharge gas low-grade waste heat, a thermal attribute referenced above, may be employed as a heat source for regeneration gas heating or glycol reboiler heating.

Determination of the efficiency of all unit operations and the complete operation may be done with suitable modelling platforms known to those skilled. One possible example is the Schlumberger platform Symmetry. Other examples include dataPARC, PetroSim, Aspen HYSYS, E2E, etc. It will be appreciated by those skilled in the art that some or all selected platforms may be used in combination. These may also be used partially with variations to be discussed.

In some of the methods disclosed herein, the methods may take advantage of:
rearranging the sequence of the unit operations;
removing at least one of the unit operations:
subdividing at least one of the unit operations into a plurality of divided unit operations;
operating selected unit operations serially, in parallel and combinations thereof:
varying at least one of rate, duration, recirculation and combinations thereof of a stream being processed;
inducing laminar flow, turbulent flow and combinations thereof of a stream being processed in predetermined areas of said first process and/or the second process;
inducing quiescent, pulsed, continuous and combinations thereof a stream being processed in predetermined areas of the first process and/or the second process;
and
any combination of the aforementioned.

In terms of applicability of the methods discussed herein, one embodiment may be to utilize a mixing module for injection, mixing and separation of glycol in multiple stages to replace a glycol contactor/absorber tower and optimize system performance by injecting lean glycol at each stage versus injecting everything into the front end. In this manner, the glycol injection unit operation is subdivided into suboperations.

For EOR (enhanced oil recovery) applications, an embodiment may use a dehydration scheme for bulk water removal only, followed by a TEG or mole sieve dehydration process or other suitable process to achieve the necessary level of dryness for the EOR application. In embodiments herein this may be followed by a secondary dehydration process which generates a cooled synthesized stream that cools the gas to the EOR required temperature for liquids recovery. Beneficially, such an amalgamation of optimized unit operations, would, for example, eliminate continuous methanol injection.

In respect of other examples where a TEG (triethylene glycol) dehydration system may be employed as the existing dehydration protocol and the cooling stream synthesis stage may be located upstream of the TEG protocol where the TEG processed stream is the initial feed stream for further processing as the feed stream contacting the cooled stream from the synthesis stage.

The specific requirements of combining two or more dehydration processes can be adapted to the application, but it is based on a thorough understanding of the original process and identification of the key parameters which will define process simplification in terms of removing units and/or improving the efficiency of operation. As a particular benefit to this is the ability to meet final product specifications for a wider range of end uses and users. The benefits of any given combination will vary depending on whether it is a new (greenfield) design or a retrofit of an existing design (brownfield).

While combining two or more processes that focus on water dehydration, the methodology herein facilitates an opportunity to simultaneously remove additional components while taking advantage of the inherent benefits as previously described. For example, in an adsorption-based dehydration, additional media could be placed within the adsorption bed or be part of a secondary adsorbent bed process that could target the removal of these components. The regeneration system in this case may require separate processing/conditioning to manage the mass balance of these components. In these cases, the ability to condition the feed temperature may be used to optimize the design.

In an absorption based process, secondary wash loops with an affinity to a given component could be added downstream or even within the same primary TEG dehydration system. Once again, this unit could be structured to utilize the same benefits as discussed previously.

Conventionally, the use of stripping gas is used to further decrease the water content in the lean TEG while still maintaining a maximum TEG regenerator reboiler temperature (such as 400° F.). The regenerator temperature must be limited to prevent a thermal degradation of the TEG solution. Treated gas is used as the stripping gas and it is typically fed at a rate that is ratioed with the lean TEG circulation rate. The value of the stripping gas to solvent ratio is set based on the desired water content in the treated gas for a given set of conditions. This facilitates adjustment of the concentration of the lean TEG. This stripping gas will ultimately end up in the regenerator overheads which also contains the water removed from the regeneration process as well as smaller quantities of other dissolved gases and entrained TEG. This gas may be vented, incinerated or combusted resulting in a not insignificant amount of CO₂ being released to the environment which is often counter to the overall objective of the larger facility.

As such, a vapor recovery unit (VRU) comprised of a compressor and associated heat exchange and separation equipment may be installed to recycle this stream to a lower pressure stage of the compressor. Any water condensed in this process would be handled in the low pressure stages of separation. The addition of the VRU not only adds to the total number of pieces of equipment and CAPEX, OPEX and maintenance costs of the VRU, but it will also increase the required power all of the compression stages subsequent to the injection point of the VRU gas attributed to the recycled CO₂.

The function of the conventional TEG unit has been thoroughly investigated however, there are numerous key improvements and advantages by combining, for example, two dehydration processes in series as will be elucidated herein after.

By observing the methodology discussed herein, immediate benefits accrue in all areas for many dehydration techniques, namely:
a reduction in the length of the contactor;
improved performance of the glycol water pickup due to the lower operating temperature;
a reduction the glycol circulation rate;
a reduction/elimination of the need for stripping gas;
facilitation of the use of carbon steel instead of stainless due to the lower water content of the main gas stream entering the system; and
mitigation of maximum capacity issues of the existing dehydration protocol to allow continued operation without increasing tower size, reboiler size or pump circulation rate.

In situations where the existing dehydration protocol may be a mole sieve dehydration system, the cooled synthesized stream may be implemented upstream for bulk water removal to offload the mole sieve dehydration and improve the performance of the solid adsorbent (mole sieve) due to the lower operating temperature. Benefits of this amalgamation include, as a minimum, longer periods between regeneration cycles and reduced hydrocarbons (where present) entering mole sieve. Hydrocarbon presence would have to be controlled by condensation as warm hydrocarbon gas contacting cold mole sieves on a start-up or free liquids contacting the mole sieves. Either of these is known to damage or otherwise degrade the mole sieve over time. By preconditioning the initial feed stream to be treated by the mole sieve, the treatment with synthesized cold stream very effectively condenses a significant volume of the hydrocarbons in advance of treatment in the mole sieve processing. As an attendant benefit, since the colder gas has a higher density, it is believed that increased kg/hr should be able to pass through the tower for the existing size relative to warmer gas.

It has been discovered that the molecular sieve/solid desiccant will operate more efficiently at a lower tower operating temperature during the adsorption cycle.

In some embodiments, a cyclonic device may be employed to enhance mixing of a dehydration recycle stream with the main acid gas stream as well as subsequent separation of water/liquids from the acid gas phase.

In some embodiments, injection of a portion of the liquids generated from the dehydration process into the upstream wet gas may be implemented. The warm gas in this operation would flash the high CO₂ loaded liquid stream, cooling it and requiring less Joule Thomson throttle.

As further examples of the thermal attribute noted above, recycling dense phase CO₂ as a supplemental cooling source for subcooling/condensing medium may be used in some embodiments to simplify process configuration and provide additional cooling capacity.

As a still further use of the thermal attribute, the cooled recycled slipstream of the dehydration process may be used to cool the vapor/condense solvents (TEG/Water/Amines etc.) from treated gas streams in in absorbent based dehydration/Carbon Capture/Amine Systems/DAC etc.

Further still, in some embodiments, cooling a recycled slipstream of dense-phase acid gas using a cross-exchanger with an amine/carbon capture contactor would be useful to remove the exothermic reaction heat capture capacity/operating behavior.

In some embodiments, using a dehydration circuit or process upstream of a membrane dehydration system for bulk water removal would offload the membrane dehydration and improve the performance of the system by extending cycle time reducing number of required membranes, etc.

According to a further object of one embodiment of the present invention, there is provided a natural gas processing method, comprising:
providing a natural gas stream containing condensable material;
treating the natural gas stream to a first processing circuit to dehydrate and/or recover the condensable material;
forming chemical, mechanical and/or thermal production attributes from treating the natural gas;
feeding the treated stream to a second processing circuit composed of a plurality of unit operations;
utilizing at least one of the attributes at a predetermined location in the second circuit;
optimizing the efficiency of a unit operation associated with the predetermined location through interaction with at least one of the attributes, optimization being relative to a unit operation absent the interaction; and
forming a processed natural gas stream from the second circuit with predetermined properties.

The natural gas stream may be preconditioned with the processed natural gas stream by recirculation prior to treatment in the first processing circuit. It will be appreciated that the stream may be a fluid stream containing gas, natural gas, liquid, entrained material and any combination thereof. Applicability of the technology herein extends to such combinations as would be understood by processing scientists and engineers.

Advantageously, embodiments of the methods facilitate introduction of the processed natural gas stream at predetermined locations within the first processing circuit, the second processing circuit and combinations thereof.

Any one, some or all of the attributes may be utilized in a plurality of predetermined locations within the second circuit.

Depending upon circuit requirements, the first and second processing circuits may include similar unit operations. Further, in some embodiments, treatment in the processing circuit and the second processing circuit form intermediate produced streams. The produced streams may have different chemical, thermal, mechanical and states of matter relative to one another.

Further still, intermediate produced streams may be introduced at predetermined locations in the first and second processing circuits.

In additional embodiments, at least one of the intermediate produced streams may be contacted with the natural gas stream prior to treatment in the first processing circuit.

Another object of one embodiment of the present invention is to provide a method for synergizing fluid processing circuits, comprising:
treating a feed stream in a first fluid processing circuit configured to dehydrate said feed stream;
recovering at least one of chemical, mechanical and thermal attributes resulting from treating said feed stream;
selecting a second fluid processing circuit for synergized combination with said first fluid processing circuit;
analyzing at least one of individual unit operations efficiency and circuit efficiency in at least one of said first fluid processing circuit and said second fluid processing circuit; and
utilizing at least one of the recovered attributes in a predetermined location in said second fluid processing circuit for at least one of:

selectively recovering components present in a feed stream to be treated in said second fluid processing circuit stream otherwise not recoverable in the absence of attribute utilization;
optimizing individual unit operations efficiency in said second fluid processing circuit;
optimizing complete second fluid processing circuit efficiency; and
combinations thereof.

Synergizing may include the step of utilizing a third fluid processing circuit, recovering components in the feed stream in the first fluid processing circuit, recovering attributes from the treated feed stream treated in the first fluid processing circuit and any combination of these. As possible examples, the components may include water, condensables, non-condensables and CO₂. Owing to the flexibility inherent with synergizing the circuits, other components will be apparent to those skilled.

As a further object of one embodiment of the present invention, there is provided a method for optimizing a selected parameter of a pre-existing process circuit to form a modified circuit, comprising:
selecting a desired final parameter for modified circuit based on the pre-existing circuit;
analyzing the pre-existing circuit for unit operation efficiency;
selecting at least one auxiliary circuit composed of potentially complementary unit operations to unit operations in the analyzed circuit, the potentially complementary unit operations each having characteristic thermal, chemical and mechanical attributes:
providing a computer based process modelling platform;
amalgamating at least one of: said auxiliary circuit, potentially complementary unit operations, thermal attributes, mechanical attributes and chemical attributes with the analyzed circuit in the platform;
selectively operating at least one of the unit operations at above or below prescribed characteristic operating standards from the platform;
adjusting at least one of implementation, timing, recirculation of the auxiliary circuit, potentially complementary unit operations, thermal attributes, mechanical attributes and chemical attributes; and
effecting the modified circuit with an optimized parameter.

Having thus generally described the invention, reference will now be made to the accompanying drawings, illustrating preferred embodiments.

### BRIEF DESCRIPTION OF THE DRAWINGS

FIG. 1 is a graphical illustration of the saturated water content of various fluids, acid gases and methane (CH₄) at 100° F. over a range of pressures;

FIG. 2 is a graphical illustration of the saturated water content of CO₂-rich mixtures and methane (CH₄) at 100° F. over a range of pressures;

FIG. 3 is a graphical illustration of the glycol losses in a prior art high pressure CO₂ service;

FIG. 4A is a schematic of an isenthalpic dehydration process according to an embodiment of the invention for a water saturated fluid stream comprising 100% CO₂;

FIG. 4B is a schematic of an isenthalpic dehydration process according to FIG. 4A for a fluid stream comprising 80% CO₂ and 20% H₂S;

FIGS. 5A and 5B are schematics of an isenthalpic dehydration process according to FIGS. 4A and 4B incorporating a heat exchanger for heating a partially expanded slipstream for preventing hydrate formation in the main process feed stream prior to further expansion of the slipstream to achieve the desired temperature reduction;

FIGS. 6A and 6B are schematics of an isenthalpic dehydration process according to FIGS. 4A and 4B, incorporating a low temperature separator for removing water from the fluid stream prior to the reintroduction of the slipstream thereto and continuous hydrate inhibitor injection;

FIG. 7 is a schematic of a multi-stage isenthalpic process according to an embodiment of the invention;

FIG. 8 is a schematic of a multi-stage isentropic process according to an embodiment of the invention wherein one of the Joule-Thomson valves is replaced with an isentropic fluid expander;

FIG. 9 is a schematic illustration of a further embodiment of the present invention;

FIG. 10 is a schematic illustration of yet another variation of the technology embraced by the present invention;

FIG. 11 is a schematic illustration of a method according to a further embodiment of the present invention;

FIG. 12 is a schematic illustration of a method according to yet another embodiment of the present invention;

FIG. 13 is a schematic illustration of a method according to a further embodiment of the present invention;

FIG. 14 is a schematic illustration of a method according to a further embodiment of the present invention;

FIG. 15 is a schematic illustration of a method according to a further embodiment of the present invention;

FIG. 16 is a schematic illustration of a method according to a further embodiment of the present invention;

FIG. 17 is a schematic illustration of a method according to a further embodiment of the present invention;

FIG. 18 is a schematic illustration of a method according to a further embodiment of the present invention;

FIG. 19 is a schematic illustration of a method according to a further embodiment of the present invention;

FIG. 20 is a schematic illustration of a method according to a further embodiment of the present invention;

FIG. 21 is a schematic illustration of a method according to a further embodiment of the present invention;

FIG. 22 is a schematic illustration of a method according to a further embodiment of the present invention;

FIG. 23 is a schematic illustration of a method according to a further embodiment of the present invention;

FIG. 24 is a schematic illustration of a method according to a further embodiment of the present invention;

FIG. 25 is a schematic illustration of a method according to a further embodiment of the present invention;

FIG. 26 is a schematic illustration of a method according to a further embodiment of the present invention;

FIG. 27 is a schematic illustration of a method according to a further embodiment of the present invention;

FIG. 28 is a schematic illustration of a method according to a further embodiment of the present invention; and

FIG. 29 is a schematic illustration of a method according to a further embodiment of the present invention.

Similar numerals used in the figures denote similar elements.

### DETAILED DESCRIPTION OF THE PREFERRED EMBODIMENTS

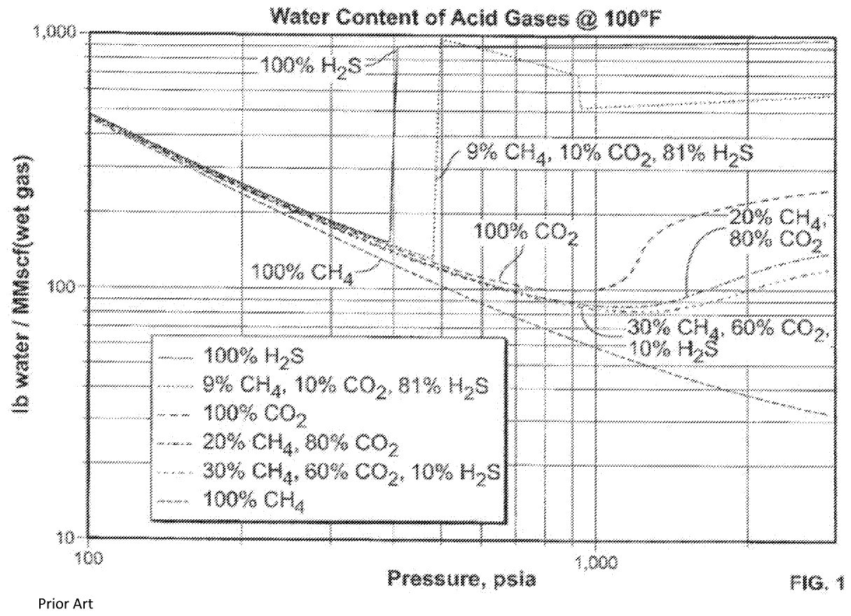

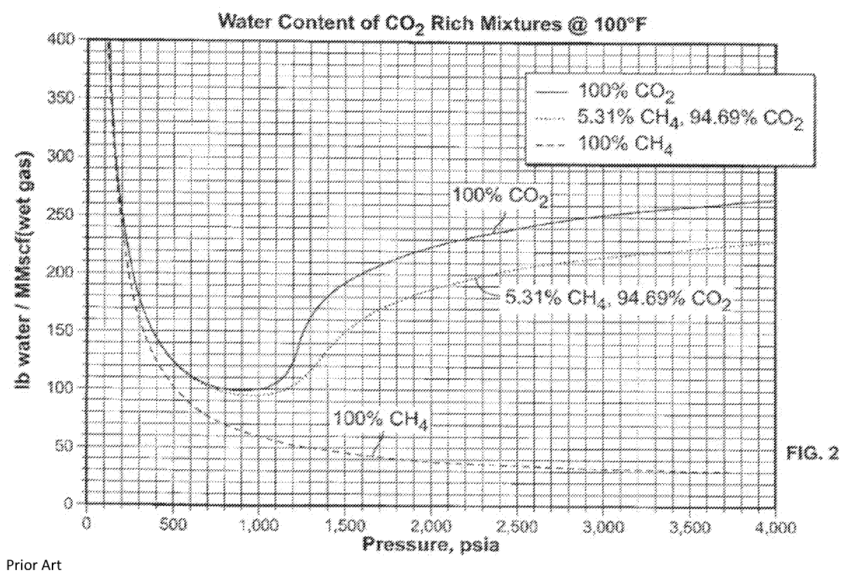

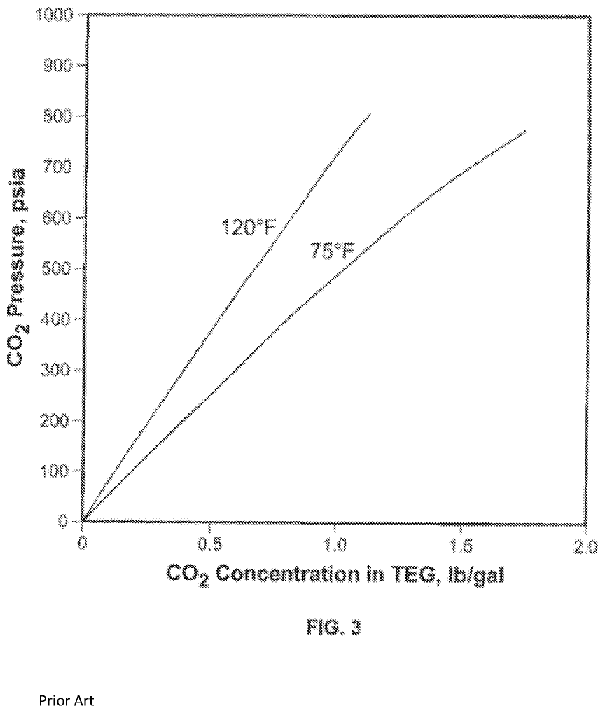

FIGS. 1 through 10 are representative of the prior art as an example to synthesize a cooling stream for use in a treatment stage where the cooled synthesized stream is contacted with a stream to be dehydrated with an existing dehydration protocol utilized in industry.

Embodiments of the invention take advantage of the thermodynamic property of typical acid gases that make them useful as a ‘refrigerant’. Such gases exhibit a relatively large temperature reduction for a given pressure reduction within the operating region of the process. The large decrease in temperature is used to cool a slipstream of the feed stream which is thereafter recycled upstream for cooling the feed stream. In this manner, the method uses recycling to “auto-refrigerate”.

The Joule-Thomson effect is achieved by allowing the gas to expand isenthalpically through a throttling device, typically a control valve. No external work is extracted from the gas during the isenthalpic expansion. The rate of change of temperature with respect to pressure in a fluid is the Joule-Thomson (Kelvin) coefficient. For example, the Joule-Thomson (JT) Coefficient for carbon dioxide at 50° C. and 60 atm. is about 5.6 times greater than that of nitrogen at the same conditions. Therefore, the temperature reduction for CO₂ would be about 5.6 times greater than for nitrogen for the same reduction in pressure at these conditions. JT Coefficient data is also available for H₂S. SO₂ and other acid gases, as well as for hydrocarbons, and inert gases, such as nitrogen and oxygen, that may be encountered.

Acid gases processed for commercial applications, such as Enhanced Oil Recovery (EOR) applications, or Carbon Capture and Sequestration (CCS) applications are normally compressed to super-critical pressures, commonly referred to as “dense phase”, for transportation and/or sequestration. To reach dense phase, compression is normally accomplished in more than one stage, whether utilizing centrifugal, reciprocating, or shock compression, depending upon the initial pressure. The pressure differential between stages provides an opportunity to take advantage of the favourable JT Coefficient properties of the vapour.

Compression is broken into two distinct regions with respect to the critical point of the fluid being compressed. The stages of compression in the first region are sub-critical and the stages in the second region take the fluid above it's critical pressure and may be accomplished by compression and pumping means. An inlet stream enters the first region of compression, which is sub-critical, and is assumed to be water saturated. Some water is naturally removed by compression through the various stages in the first region.

In embodiments related to the synthesis of the cooled stream, a slipstream of fluid from the after-cooled discharge of one stage of compression, typically near or above critical pressure, is expanded to the suction pressure of that same stage or to a preceding stage should additional temperature reduction be required. The resulting reduced temperature of the expanded slip stream is used to cool the upstream main fluid stream, firstly by heat exchange, if required, and finally by direct mixing of the slipstream with the main fluid stream. The resulting reduction in temperature of the mixed stream condenses additional water from the gas. The amount of cooling required is a function of the minimum water content required for the stream composition to meet the design criteria for water dew point temperature and/or hydrate formation temperature.

The following are examples illustrating useful embodiments:
Example 1-a basic embodiment;
Example 2-utilizing a low temperature separator vessel/separator (LTS);
Example 3-incorporating a heat exchanger (HEX);
Example 4-a multi-stage isenthalpic embodiment; and
Example 5-a multi-stage isentropic and isenthalpic embodiment.

Examples 1 through 3 are shown using different stream compositions and more particularly, a stream having 100% CO₂ and a stream having 80% CO₂ and 20% H₂S. It will be noted however that embodiments of the invention are applicable to streams having varying amounts of H₂S and including SO₂, NOₓ and any other gaseous mixtures with relatively large JT Coefficients.

Examples 4 and 5 illustrate the low temperature capabilities of embodiments of the invention as well as the differences between isenthalpic and isentropic processes.

### Example 1-Basic System

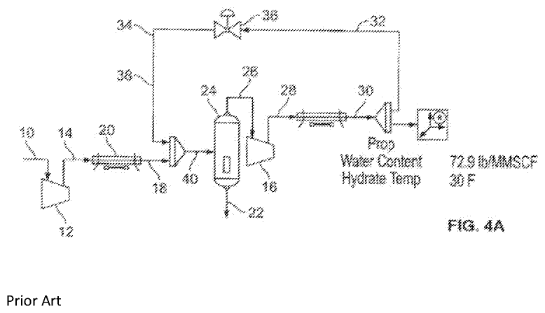

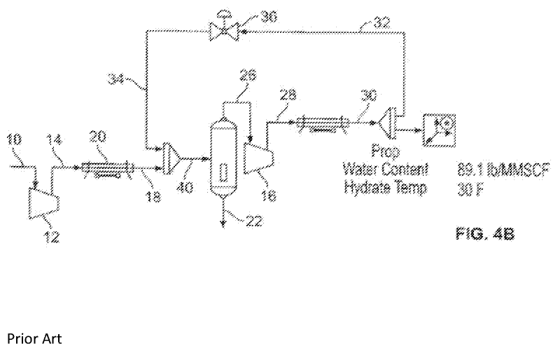

Having reference to FIGS. 4A and 4B, in an embodiment of the invention, a water saturated acid gas feed stream 10 enters a suction stage 12 where it is compressed 14 to the suction pressure of the next stage 16. The hot compressed vapour 14 is cooled 18 with an after-cooler 20 resulting in the condensation of some of the water and other condensables in the feed stream. The condensed liquid containing water is removed 22 in a separator 24 upstream of the final stage of compression. The saturated gas 26 from the separator 24 is further compressed at 28 and is after-cooled again at 30. A slipstream 32 from the compressed and alter-cooled fluid stream is removed and isenthalpically expanded 34 across a Joule-Thomson valve (TCV) 36 to the lower suction pressure of the same stage 16 of compression. The expansion results in a temperature reduction, the magnitude of which is dependent upon the magnitude of the pressure reduction and the composition of the fluid stream. The colder stream 38 is combined with the after-cooled stream 18, exiting the previous stage of compression, resulting in a combined stream 40 having a temperature reduced sufficiently to condense the required amount of water.

As shown in FIG. 4A for a leed stream having 100% CO₂, the temperature is reduced to about 87° F., and the final water content is reduced to about 73 lb/MMscf to result in a hydrate formation temperature (HFT) of 30° F.

Referring to FIG. 4B, wherein the feed stream contained 80% CO₂ and 20% H₂S, the temperature need only be reduced to about 93° F. for a final water content of about 89 Ib/MMscf to achieve the same hydrate formation temperature (HFT) of 30° F.

### Example 2-Heat Exchanger (Hex)

In cases where the composition of the feed stream, in combination with a large pressure reduction, creates a stream temperature which is below the hydrate formation temperature of the main undehydrated feed stream, the embodiment shown in FIGS. 4A and 4B can be modified to include a heat exchanger (HEX).

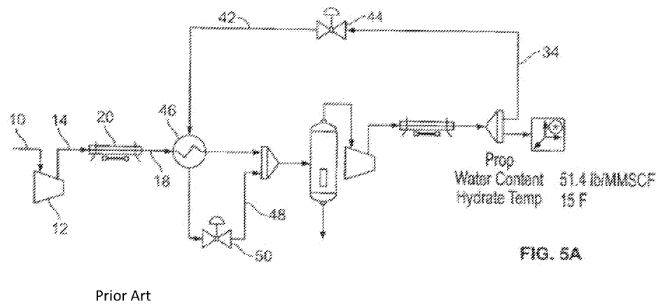

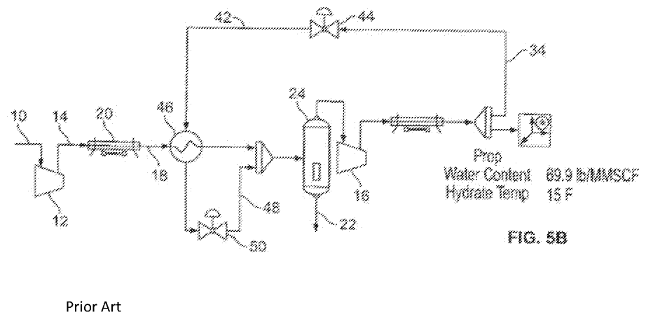

With reference to FIGS. 5A and 5B, the basic embodiment is modified so as to avoid the need for continuous injection of hydrate inhibitor, as is utilized in conventional refrigeration processes.

In FIGS. 5A and 5B, the slipstream 34 is partially expanded 42 across a second Joule-Thomson Valve (JTV) 44. The temperature of the partially expanded stream is thereafter raised in a heat exchanger 46 prior to further expansion of the stream 48 across the Joule-Thomson Valve (TCV) 50. Thus, the temperatures of the partially and fully expanded streams 42, 48 are maintained above the respective hydrate formation temperatures of the main undehydrated feed stream.

For the purposes of Example 2, the design hydrate formation temperature was set at 15° F. As shown in FIG. 5A, for a feed stream having 100% CO₂, the temperature must be reduced to about 73° F. to result in a final water content of about 51 lb/MMscf to achieve the design hydrate formation temperature of 15° F.

With reference to FIG. 5B, and in the case where the feed stream comprises 80% CO₂ and 20% H₂S, the temperature was reduced to about 79° F. to result in a final water content of about 64 lb/MMscf to achieve the design hydrate formation temperature of 5° F.

### Example 3-Low Temperature Separator

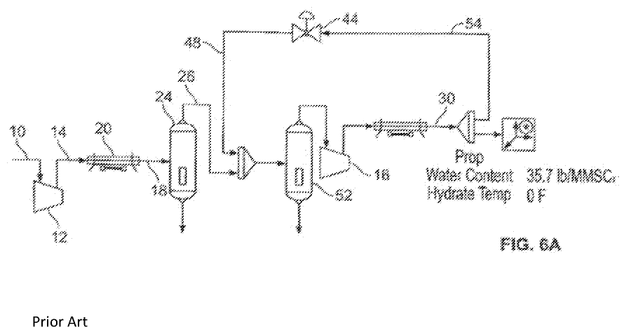

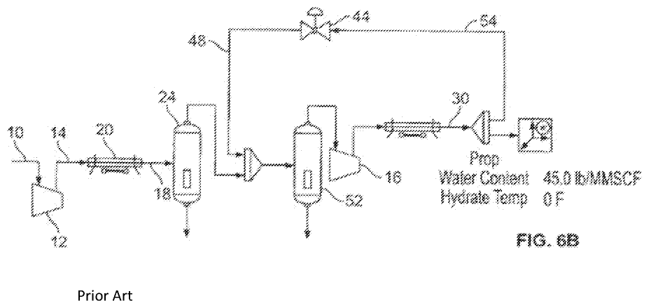

Referring to FIGS. 6A and 6B, shown is an embodiment utilizing an additional separator where temperature reduction is significant, as an alternate to the embodiment described in Example 2.

As shown in FIGS. 6A and 6B, the 46 and JTV 44 of FIGS. 5A and 5B are replaced with a second low temperature separator (LTS) 52. A slipstream 54 is expanded 56 across a Joule-Thomson Valve (TCV) 44. The first separator 24 is positioned to remove as much water as possible from the feed stream prior to the reintroduction of the expanded slipstream 48. The addition of hydrate inhibitor into the expanded slipstream 48 is considered when the process design requires that the temperature of the expanded slipstream be below 32° F. The early removal of the water reduces the amount of cooling required to meet the design conditions and should conditions warrant, reduces the amount of hydrate inhibitor required.

The design hydrate formation temperature for Example 3 was set at 0° F.

As shown in FIG. 6A, where the feed stream comprises 100% CO₂, the temperature had to be reduced to 62° F. to result in a final water content of about 36 lb/MMscf to meet the design hydrate formation temperature of 0° F.

With reference to FIG. 6B, where the leed stream comprises 80% CO₂ and 20% H₂S, the temperature had to be reduced to about 67° F. to result in a final water content of about 45 lb/MMscf to achieve the design hydrate formation temperature of 0° F.

### Example 4-Multiple Stage Isenthalpic

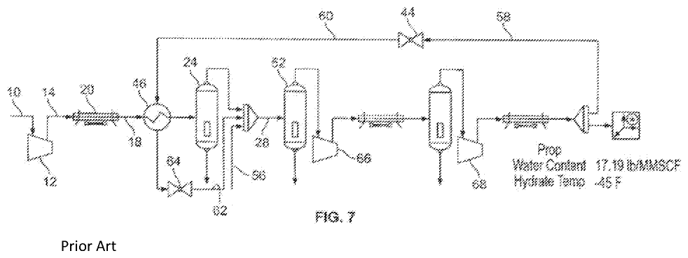

In reference to FIG. 7, a multi-stage embodiment is employed where the required temperature reduction is very large. The embodiment was designed to achieve a hydrate formation temperature of −45° F.

As shown in FIG. 7, this embodiment comprises a heat exchanger 46, a low temperature separator 52 and continuous hydrate inhibitor injection 56. The first separator 24 is positioned between the heat exchanger 46 and the reintroduction of the temperature reduced stream. The early removal of water from the feed stream reduces the amount of cooling and hydrate inhibitor required to meet the design criteria.

To obtain a lower temperature, the pressure reduction which results from the expansion of the slipstream 58 through the Joule-Thomson Valve 44 occurs over at least two stages of compression. Thus, the partially expanded slipstream 60 is heated al the heat exchanger 46 and fully expanded 62 through the Joule-Thomson Valve 64 to be reintroduced, along with the injection of hydrate inhibitor, to the feed stream two or more stages 66, 68 upstream from the removal of the slipstream 58 for cooling the feed stream 28. Condensed water is removed from the cooled leed stream 28 at the second separator 52 prior to further compression of the cooled feed stream 28.

In this example, the low temperature achieved at the fully expanded slipstream 56 and the cooled feed stream 28 necessitates the addition of the hydrate inhibitor, however the amount of hydrate inhibitor is minimized because of the upstream removal of a significant portion of water at the first separator 24.

An additional benefit of the low temperature achieved at the cooled feed streamn in this example, is the ability to reduce the number of compression stages from five stages to four stages, resulting in a reduction in the overall cost.

### Example 5-Multiple Stage Isentropic

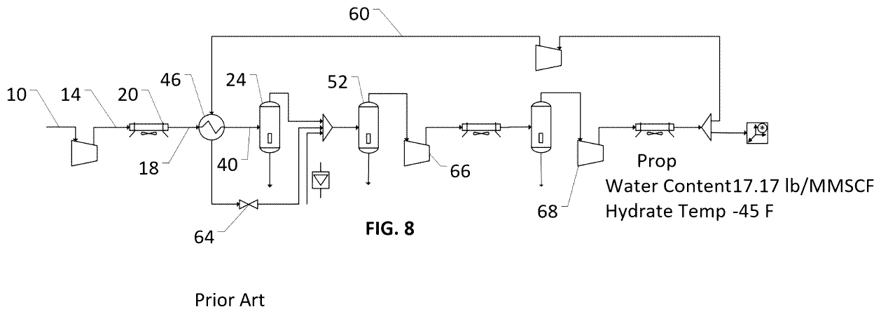

With reference to FIG. 8, a multi-stage embodiment utilizes an isentropic fluid expander 66, such as a conventional radial-expansion turbine or turbo-expander (such as is available from Mafi-Trench, Santa Maria, Calif., USA) to replace the Joule-Thomson Valve 44 of FIG. 7 for expansion of the slipstream 58.

In this embodiment, the isentropic fluid expander can achieve a lower temperature in the expanded slipstream 60 than is possible using a Joule-Thompson valve (isenthalpic expansion) for the same reduction in pressure. Additionally, the slipstream fraction required is smaller than it is in Example 4.

The power requirements for Stage 3 (66) and Stage 4 (68) for this embodiment, compared to that in Example 4, are lower by about 2%. The isentropic fluid expander produces power, about 1.8% of Stage 3 (66) and Stage 4 (68) for other uses. Further, the hydrate inhibitor requirements are minimized.

The embodiments described herein have notable advantages over and differences from conventional liquid desiccant and isenthalpic refrigeration dehydration processes.

In comparison to liquid desiccant dehydration processes, embodiments of the invention permit elimination of conventional dehydration equipment by replacement with the expansion valves (TCV, JTV) at a small fraction of the capital cost of the conventional dehydration equipment.

In comparison to conventional isenthalpic expansion refrigeration processes, such as a “Choke Plant” or “DPCU”, embodiments may permit elimination of one stage of compression, a main gas-gas heat exchanger and the addition of hydrate inhibitor, providing a significant reduction to the capital cost.

The prior art “Choke Plant” or “DPCU” requires that the entire gas stream be over-compressed and expanded to the design pressure. This typically increases the original compression power requirements of the system by 20% to 25%. Depending upon the composition of the gas and the operating conditions, the higher compressor discharge pressure may necessitate the addition of an entire stage of compression.

The cooling slipstream is typically 10% to 30% of the combined stream flow through a single stage, depending upon the composition of the acid gas and the required operating conditions. The increase in throughput through one stage of compression theoretically increases the total compression power demand by 2% to 6% (i.e. ⅕ of 10%-30% for a 5 stage compressor). In comparison however, this increase is often comparable to the increase due to the pressure drop through conventional dehydration equipment. Further, there is an efficiency improvement, and therefore a corresponding reduction in compression power, resulting from the reduced operating temperature of the compressor. In some instances, the compression power requirements end up being less than when using conventional dehydration equipment.

Lower suction temperatures, enabled by embodiments herein, have an additional advantage over both the conventional dehydrator and the choke plant. The reduced temperature in one stage provides the opportunity to rebalance the compression ratios on each stage, a higher compression ratio where the suction pressure is cooler thus enabling a reduction of the compression ratio in the others, until the discharge temperatures of each stage are relatively equal at some new lower value. The reduction in discharge temperature somewhat reduces the additional power demand arising from the additional slipstream volume seen in one or more stages of compression. The temperature reduction also results in longer valve life. increased operational lime and lower maintenance costs. The rebalancing can, at some point, with lower temperatures, be significant enough to eliminate an entire stage of compression and thus provide considerable capital cost saving.

It is known that the overall carbon footprint of embodiments herein is significantly lower than conventional methods. The requirement for equipment is considerably smaller reducing demand for manufacture, there is no need for the formulation of glycol and no additional utilities are required that produce CO₂, all of which more than offset the marginal increase in power required (typically about 2%) to compress the slipstream volume. Additionally, the lack of chemical requirements in embodiments of the invention significantly reduces ecological risk.

Acid gases including CO₂, H₂S, SO₂, and NOₓ are fluids well suited to the embodiments of the methods set forth herein.

It is to be noted however that the fluids are not limited to those disclosed within this specification. The thermodynamic principles utilized in embodiments are valid for all fluid mixtures exhibiting a positive Joule-Thomson (JT) Coefficient within the desired range of process conditions; in the vernacular, the fluid mixtures cool when expanded. As a generalization, a fluid with a larger JT Coefficient will get colder than one with a smaller JT Coefficient and therefore will require less of the fluid to be slipstreamed. A low slip stream requirement is economically desirable.

Applications for embodiments of the invention lie in carbon capture and storage (CCS), the treatment of CO₂, SO₂, and NOₓ captured from combustion, gasification and industrial chemical processes for sequestration, and in AGI (acid gas injection) where H₂S and CO₂ are captured from oil and gas processes for sequestration.

Additionally, embodiments discussed herein are very beneficial in the recovery of hydrocarbon liquids from relatively high acid gas content solution gas vapours that are typically processed in Enhanced Oil Recovery (EOR) applications.

A particularly effective application for embodiments of the invention lies in situations where acid gas dehydration is required in situations with minimal available space or where there is a weight restriction. By way of explanation, such a situation might occur in offshore floating production operations or in retrofit applications, both onshore and offshore. The configurations disclosed herein provide a significant space and weight advantage over other commercial dehydration means.

Examples 1 through 5 supra are based upon a single set of conditions. Embodiments of the invention require optimization for each fluid and set of conditions. Optimization involves the selection of the stage of compression best suited for initiation of the slipstream and which is best suited for recombining the slipstream. Another optimization lies in the selection of the optimum variation of the process whether it be Basic, HEX, LTS, Multi-Stage, Mulli-Stage Isentropic, or some other combination of those described above. Also, within any of the choices, the optimum instrumentation and control system needs to be included and the optimum operating points for the application established.

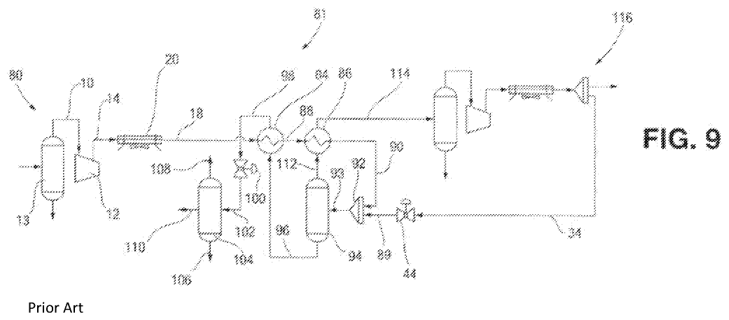

Referring to FIG. 9. numeral 80 denotes common upstream operations with numeral 81 denoting the overall schematic process according to a further embodiment.

With respect to the common numerals from the previous embodiments, a separator 13 is provided for separating a feed into saturated gas feed stream 10 which enters compressor 12 where it is compressed to the discharge pressure, compressed vapor 14 is then introduced into after cooler 20 which results in the condensation of some of the water and other condensables in the feed stream.

Upstream acid gas stream 18 which is typically from a compressor, well, etc. is normally saturated with water. As an example, the stream may contain 100% acid gases or some other concentration of acid gases with the balance typically being hydrocarbons and low concentrations of other inert gases.

For purposes of explanation, the stream may be at for example, 120° F. at a pressure of 600 psi. In this circuit, a pair of heat exchangers 84 and 86 are provided. In terms of the heat exchangers 84 and 86, heat exchanger 84 is a gas-liquid heat exchanger which is used to transfer heat in fluid 18 to the cold liquid fluid 96. Stream 90 mixes with the cooled stream 89 exiting the Joule Thomson valve 44. The two are mixed in mixing device 92. The so formed mixture 93 at a temperature of approximately 50° F., is passed into low temperature separator 94. At this point, the liquids that condense at the 600 psi pressure form a cold liquid stream 96. Stream 96 will be close to the hydrate formation temperature of the mixture of fluids. If the stream were further depressurized this would most certainly result in the formation of a hydrate. Stream 96 passes into heat exchanger 84, exchanges heat with, stream 18 thereby cooling stream 18 and warming stream 96. It is advantageous for stream 96 to receive some heat from stream 18 to reduce the probability of hydrate formation. It is also advantageous to cool stream 18 to reduce the amount of additional cooling required. Once stream 96 is warmed via heat exchange through exchanger 84, stream 98 is possibly at a temperature of 120° F. The pressure of stream 98 can then be reduced in valve 100 without hydrate formation, to maintain a desired liquid level in the low temperature separator 94. As the liquid level builds, valve 100 opens and allows a stream 102 to pass into a three phase separator 104. Stream 102 is possibly comprised of three phases; vapor, hydrocarbon liquid, and water. The residence time in the separator 104 is sufficient to facilitate the separation of heavier liquids at 106, typically water, vapor at 108 and lighter liquids at 110, typically hydrocarbons. At this point, the separated hydrocarbon liquids 110 can be then directed to an oil treating facility for treatment (not shown), stabilization, and eventual sale.

Returning to the low temperature separator 94, the stream 112 exiting same is a cold acid gas (typically CO₂) vapor stream and can be used as an additional source for pre-cooling the main system. Streams 88 and 112 are passed into the heat exchanger 86 which, in this case is a gas-gas heat exchanger used to transfer the heat in stream 88 to the cold vapor stream 112 exiting the low temperature separator 94. This also pre-cools stream 90 exiting the exchanger 86 thereby reducing the amount of additional cooling required. The stream 114 at this point has a temperature of approximately 110° F. from the example noted herein. This system is particularly beneficial in that it allows for hydrocarbon recovery where it is economically feasible.

Stream 114 is then passed into the unit operations that have been described herein previously with respect to the basic overall system.

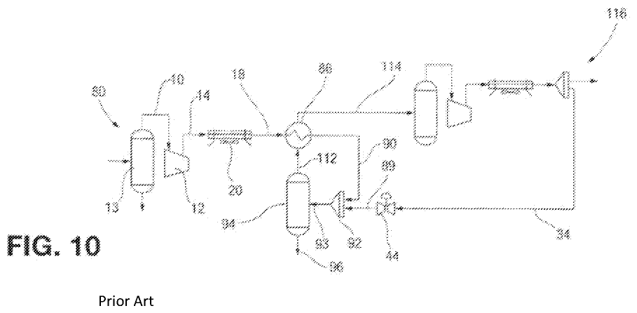

If there is no possibility, or where it is not economically feasible to recover liquid hydrocarbons, then the designer would employ the system shown in FIG. 10 to be discussed in greater detail herein after. This is also an attractive system for retrofit applications which could use existing compressor arrangements with minimal modifications while also benefiting from the technology set forth herein.

In an EOR application where CO₂ is utilized, make-up or additional CO₂ is usually mixed with the produced vapor and reinjected into the producing reservoir. Depending upon the pressure of the make-up CO₂ stream, it may be mixed with or even replace stream to improve the Joule-Thomson coefficient and to reduce the HFT. The dry, make-up CO₂ could be used to minimize or eliminate usage of hydrate inhibitors, such as methanol or glycol, during system start up. The process may be designed to condense fluids other than the hydrocarbons used in this example if so desired.

Additional stages of pressure reduction and separation (duplicating 100, 102 and 104 with 110 replacing 98) may be considered if improved hydrocarbon liquid/vapor separation efficiency is required.

Further, the system may include thermodynamic simulation software to assist in optimizing operating points by predicting water dew point, hydrate formation temperature, and hydrocarbon recovery.

Turning to FIG. 10, shown is a further embodiment. In this embodiment, it is evident that a significant number of unit operations have been removed relative to that which is shown in FIG. 9. The use of the three phase separator 104 from FIG. 9 is unnecessary in this embodiment as is the gas-liquid heat exchanger. The remaining unit operations are similar to the functioning of operations in FIG. 9 and the overall sequence will be apparent to one skilled in the art.

This embodiment is particularly well suited for existing arrangements where a retrofit is possible to take advantage of the benefits of the system described herein. With the inclusion of the gas-gas heat exchanger, the cooling slipstream is typically reduced to 4% to 10% of the combined stream flow through a single stage, depending upon the composition of the acid gas and the required operating conditions. The increase in throughput through one stage of compression theoretically increases the total compression power demand by 1% to 2% (i.e. 1/5 of 4%−10% for a 5 stage compressor). The addition of the LTS is only required where the metallurgy of the existing suction scrubber is not compatible with the acidic water produced and it is deemed inappropriate to replace the existing scrubber. The capital cost of this embodiment is increased accordingly.

In the embodiment shown in FIG. 10, the heavy liquid phase stream 34 in this instance is typically a warm high pressure recycle stream which is typically super critical (dense phase) or liquid. This is passed into the Joule Thomson valve 44 which reduces the pressure and therefore the temperature of the stream 34. Cold low pressure recycle stream 89 is used for mixing with the pre-cooled inlet stream 90 into the mixing device 92.

The mixture, as previously discussed with respect to FIG. 9, is denoted by numeral 93. The liquid phase leaving the low temperature separator 94 at 96 is predominantly water. This stream is typically blended elsewhere into a water treatment process.

As an example, stream 90 may be cooled to approximately 60 to 70° F. depending on how much surface area is available in the heat exchanger 86. The slipstream 34 (as discussed herein previously with respect to the other embodiments) may be at 120° F. and possibly at 2,000 psig. This high pressure stream may be depressured in a Joule Thomson valve 44. Here it is depressured to approximately the same pressure (600 psig) as stream 90. As a result of passing through the Joule-Thomson valve, the stream is expanded and thus cools to approximately 40° F. for purposes of this example. The resulting cold stream 89, is mixed with stream 90 in mixing device 92. The so formed mixture 93 at a temperature of approximately 50° F., is passed into low temperature separator 94. At this point, the liquids that condense at the 600 psi pressure form a cold liquid stream 96. The stream 112 exiting separator 94 is a cold acid gas (typically CO₂) vapor stream and can be used as a source for pre-cooling the hot inlet stream 18. Streams 18 and 112 are passed into the heat exchanger 86 which is a gas-gas heat exchanger used to transfer the heat from stream 18 to the cold vapor stream 112 from the low temperature separator 94. This heat exchange also pre-cools stream 90 exiling the exchanger 86 thereby reducing the amount of additional cooling required. The stream 114 at this point has a temperature of approximately 110° F. from the example noted herein.

This completes one example of a synthesis of a cooled stream for use in the present invention. In the advancing figures, utilization of aspects of the cooled stream and general method will be delineated in a host of other applications and process benefits in known industrial dehydration protocols.

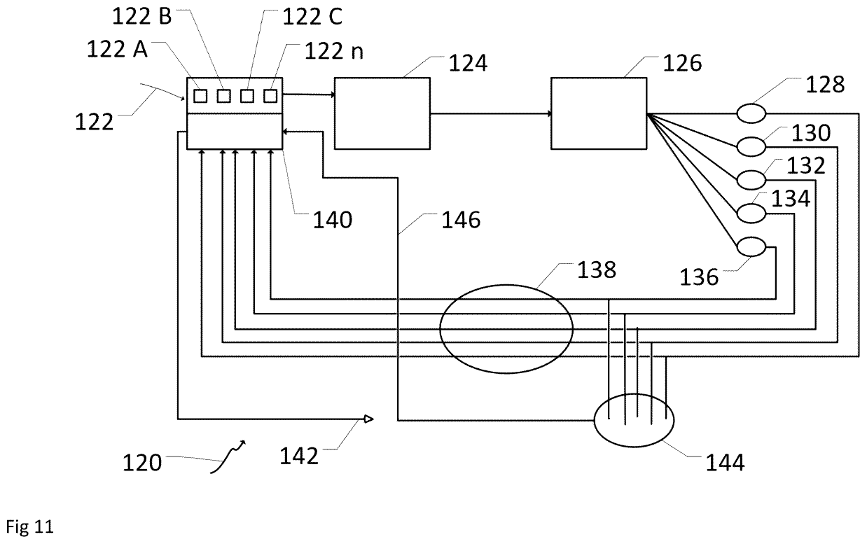

FIG. 11 schematically illustrates an amalgamated method using, as an example, the methods set forth in FIGS. 1 through 10. An optimization scheme for an acid gas dehydration circuit is globally represented by numeral 120. The initial circuit 122 incorporating unit operations 122A, 122B and 122C, for example, is analyzed at 124 regarding parameters such as temperature, pressure, throughput, heat recovery, flowrate, hydrocarbon content, water content inter alia further parameters being appreciated by those skilled when analyzing a process circuit in respect of the unit operation and global efficiency. Any suitable technique or combination of techniques may be used to ascertain efficiencies of specific unit operations 122A, 122B and 122C inherent in the initial circuit 122.

Once the circuit is analyzed, referenced by numeral 126, suitable unit operations 128 through 136 may be implemented to enhance the suboptimal efficiencies in the circuit from the analysis. Once implemented, the circuit is effectively modified as represented by numeral 140. Based on data acquired from the analysis of the circuit 126, location, duration and sequencing parameters of selected unit operations 128 through 136 are determined as represented by numeral 138.

Once optimization of the modified circuit is realized, the modified circuit can be operated with an optimized resultant stream 142.

In the example, the initial circuit may include a natural gas stream requiring processing to reduce water content, acid, etc. The example illustrates unit operations 122A, 122B, 122C, however it will be apparent that this is for purposes of explanation; the circuit may contain any number of unit operations 122 . . .

In analyzing the circuit, some unit operations 122A, 122B, 122C, 122,, 128,130,132,134,136 may be removed, repositioned, subdivided into subunit operations, operated in a specific time delayed sequence, etc.

Dynamic assessment may be included at 144 where at least the unit operations 128 through 136 may be assessed/altered for processing flexibility. Any assessments/alterations can then be effected to alter modified stream 140 as represented by numeral 146.

The assessment/alteration may be automatic and acquired information from the assessment utilized for modification of an underperforming unit operation in the modified circuit or elsewhere within circuit 120.

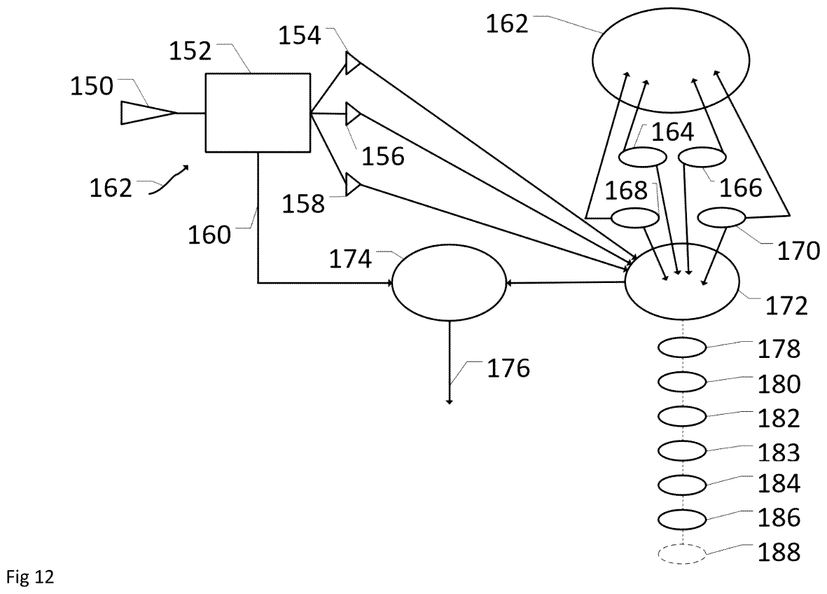

Referring now to FIG. 12, shown is a further embodiment of the present invention for processing raw natural gas. The overall process is denoted by numeral 162.

A feed stream of raw natural gas 150 is treated with a first process 152, such as an amine process, methanol, process, acid gas dehydration process, etc. The first process 152 may produce one, some or all of chemical 154, mechanical 156 and thermal 158 useful attributes, such as slipstreams, chemical streams containing condensables, positive and negative pressure, heating, cooling, dedicated compression and expansion, aerosols, inter alia. A processed stream 160 is formed from the first process 152. Several processed streams may also be produced.

A second process 162 for treating the stream 160 is composed of a series of unit operations denoted by numerals 168 through 170. The second process 162 may be a suitable natural gas processing circuit known in the industry. Four unit operations are shown, however, as in the explanation in respect FIG. 11, supra, any number of operations may be associated with the process 162.

A determination of the efficiency of the individual unit operations 164 through 170 and the operation as a whole is determined through analysis of the engineering parameters as denoted globally by numeral 172.

Once determined, utilization of one some or all of the attributes chemical 154, mechanical 156 and thermal 158 may be combined with anyone or all of the unit operations 164 through 170 to augment the determined efficiency of said at least one of the unit operations 164 through 170 to form a modified second process 174.

Advantageously, the now enhanced modified second process (a known industrial process with improved efficiencies) can then treat the stream 160 to provide a resultant refined natural gas stream 176.

Owing to the flexibility of the overall method in FIG. 12, other parameters denoted by numerals 178 through 188 may also be modified to ensure maximum efficiency in respect of energy, materials and equipment is realized. Such parameters include but are not limited to rearranging the sequence of the unit operations 164 through 170, removing at least one of the unit operations, subdividing at least one of the unit operations into a plurality of divided unit operations, operating selected unit operations serially, in parallel and combinations thereof, varying at least one of rate, duration, recirculation and combinations thereof of a stream being processed, inducing laminar flow, turbulent flow and combinations thereof of a stream being processed in predetermined areas of the first process 162 and/or said second process 174, inducing quiescent, pulsed, continuous and combinations thereof a stream being processed in predetermined areas of the first process 162 and/or the second process 174 and any combination of the aforementioned.

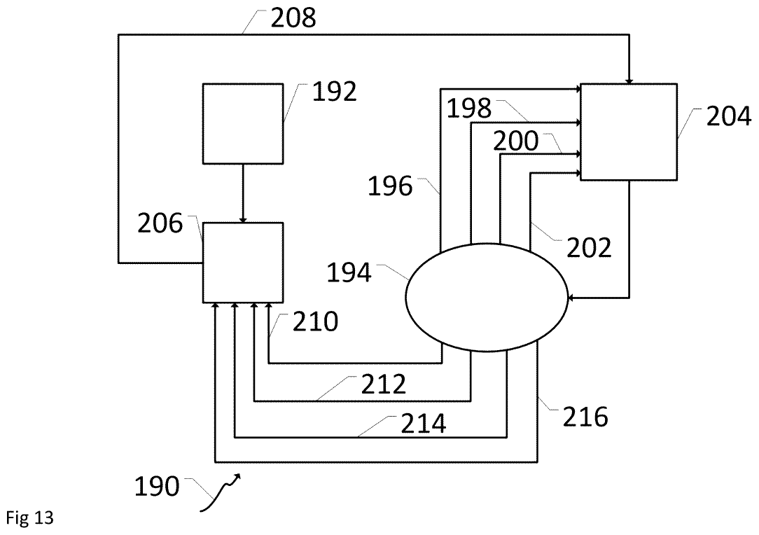

Turning now to FIG. 13, shown is further method according to one embodiment of the present invention.

In the Figure, numeral 190 globally references a system according to one possibility of the invention. A portable module 192 which may be a natural gas dehydration circuit is utilized. An analyzed circuit 194, analyzed as discussed herein previously in respect of FIGS. 11 and 12, includes a plurality of unit operations 196 through 202 in communication with a data acquisition device 204.

An operations control device 206 is in communication with data acquisition device 204, denoted by numeral 208, and the unit operations as denoted by numerals 210 through 216 to allow for dynamic adjustment of operating parameters associated with the unit operations 196 through 202. Data acquisition device 204 is also in communication with analyzed circuit 204. In this manner, effective real time adjustment of the method is achievable.

Suitable components for devices 204 and 206 will be appreciated by those skilled in the art.

The benefit of analyzing the efficiencies of fluid processing schemes allows for equipment removal and concomitant unit operation elimination as noted in the methods discussed herein. As an example, a mole sieve dehydration inlet filter coalescer may be eliminated by using the low temperature separator, discussed above in respect of FIGS. 1 through 10, for both removal of bulk condensed water as well as for solid removal with the integration of an upper filter separation chamber to the vessel.

There are many additional configurations of an absorption process that are possible when considering different configurations of contact type (trays, packing, sprayed, static mixer etc.) feed configuration (split flow, semi lean, etc.) and heat exchange configuration considering the unique feed conditions provided that can be optimized for a variety of parameters (minimum CAPEX, OPEX/turn down/footprint/equipment weight etc.) for a given application.

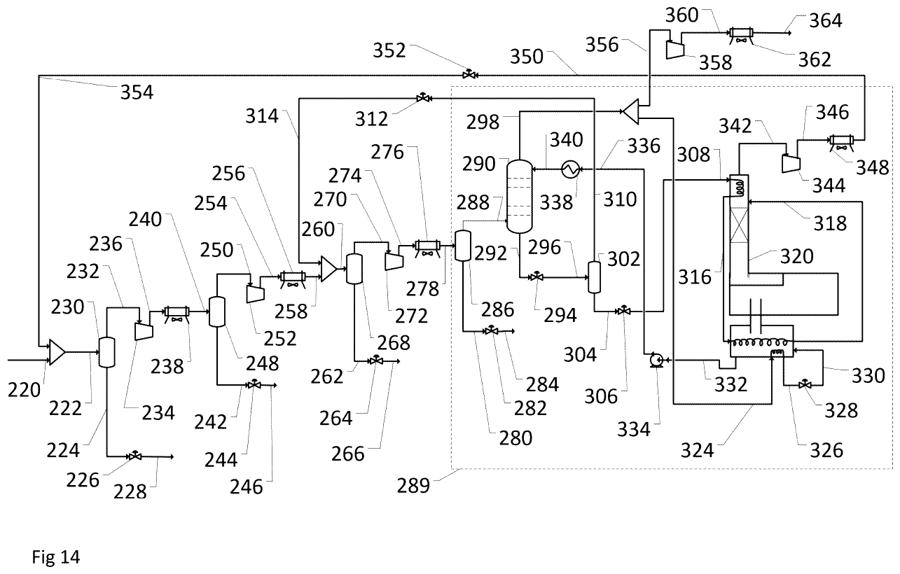

As a preface, details will be discussed for FIGS. 14 through 22, followed by comparative and additional explanatory examples. Redundancy in some explanations is to ensure full clarity. The scenarios that follow this detailed unit operations specification, will characterize the consequential sophistication of synergizing circuits.

Referring now to FIG. 14, a feed stream, which may have been preconditioned in a preliminary operation, to be compressed and dehydrated is denoted by numeral 220. This stream is mixed with a recycled stream 354 which comes from the overhead of the TEG regenerator (the details of which will be described subsequently).

The combined stream 222 flows into separator 230 to separate the vapor from the liquids that are contained in the combined stream. The liquids pass through stream 224 and valve 226, which may act as a level control valve and then to stream 228 generally representative of disposal or further handling of the liquids.

The vapor stream 232 passes to a first stage of compression 234 which increases the pressure and temperature of the fluid exiting the compressor in stream 236 which then passes into a cooler 238 cooling the stream. This cooling is necessary before the next stage of compression and will also have the tendency to drop a significant amount of liquid water from the stream as the water holding capacity of CO₂ tends to decrease with increased pressure at these expected pressure ranges.

Stream 240 flows into separator 248 which separates the vapor and liquids that are contained in the stream. The liquids stream 242 pass through valve 244 which, similar to the above reference, may act as a level control valve and then to stream 246 indicative of disposal or further handling of the liquids.

The vapor stream 250 passes to a second stage of compression 252 to increase the pressure and temperature of the fluid exiting the compressor in stream 254 which then passes into a cooler 256 to cool the stream. This cooling is necessary, as noted above, before the next stage of compression and will also have the tendency to drop a significant amount of liquid water from the stream as the holding capacity of CO₂ tends to decrease with increased pressure at these expected pressure ranges. The cooled stream 258 is mixed with 314 to form a combined stream 260. This flows into separator 268 which separates the vapor from liquids that are contained in the stream. The liquids stream 262 passes through valve 264 and then to stream 266 which represents disposal or further handling of the liquids.

The vapor stream 270 passes to a third stage of compression 272, which increases the pressure and temperature of the fluid which exiting the compressor in stream 274 and then passes into a cooler 276 which cools the stream. This cooling is necessary to aid in the effective removal of water in the TEG absorber, which is generally favored at lower temperature, the cooling will also have the tendency to drop a significant amount of liquid water from the stream as the holding capacity of CO₂ tends to decrease with increased pressure at these expected pressure ranges.

Stream 278 flows into separator 286 which separates the vapor from and liquids that are contained in the stream. The liquids stream 280 passes through valve 282 which could act as a level control valve and then to stream 284 which represents disposal or further handling of the liquids.

The vapor 288 passes into the TEG Absorber contactor 290 as the vapor feed which will ultimately be contacted by a lean (in water) TEG solution which enters contactor 290 via stream 340. Within 290 there are contacting devices such as trays or packing to facilitate the mixing of the descending liquid with the ascending vapor which will selectively remove water from the vapor by absorbing it into the liquid.

The dehydrated vapor stream leaves contactor 290 in 298 and the rich (in water) TEG solution leaves in 292, 292 passes through valve 294 which acts as a level controller for the sump of 290 and drops the pressure of the stream to the second stage suction pressure found in 268. This will result in a significant amount of CO₂ which is dissolved in the TEG solution flashing from the liquid in stream 296 which then enters 302 for separating the flashed vapors from the rich TEG

### Solution

The vapor 310 from 302 flows through valve 312 (which can be used to help control the back pressure of 302) to stream 314 which is combined with 258 as previously mentioned. The recycling of the vapor from 302 prevents the loss of CO₂ from the overall system. The liquid stream 304 leaving 302 passes through valve 306 which can be used to control the level in 302 as stream 308 for passage into a heat exchanger section 316 which removes heat from the overhead vapors of TEG regenerator 320. This acts to both provide some preheating to the rich TEG as well as providing a cooling to the overhead vapors providing some condensation and reflux to 320.

Upon leaving this heat exchanger section 316, the partially heated rich TEG passes through a second heat exchange section which exchanges heat with the hot regenerated TEG in the accumulator below the TEG reboiler. This will both further preheat the rich TEG before entering the TEG regenerator 320 in stream 318, which acts to recover heat from the system and help to minimize the total heat input, and also to slightly cool the lean TEG that was just regenerated before being recirculated for use in 290.

Upon entering 320 the rich TEG stream will contact vapors generated in the lower part of the regenerator in the reboiler. This contact is facilitated with a contacting device such as trays or packing. The vapors will be comprised of more volatile components such as water and CO₂ and will concentrate as they move up the tower, this results in the TEG solution increasing in concentration of TEG. Typically, a TEG regenerator is run a nearly atmospheric pressure as this helps improve the effectiveness of the purification of the TEG solution particularly considering there is a maximum allowable temperature that the TEG solution can be exposed to before it starts to substantially degrade.

As an extra possibility of enhancing the amount of regeneration the TEG solution can experience with these conditions, an amount of dehydrated CO₂ 330 may be injected into the TEG regenerator through various means. In the example, it is shown as being sparged into the hot regenerated TEG accumulator. This gas is commonly referred to as stripping gas and works to increase the TEG concentration in the lean TEG by reducing the partial pressure of water in the vapor space of the 320 shifting the equilibrium to allow more water to leave the TEG solution.

The stripping gas is split from the dehydrated gas stream 298 passes through stream 324 before passing through a heat exchange section where the stripping gas is preheated through heat exchange with the hot regenerated TEG in the accumulator.

The preheated stripping gas 326 then flows through valve 328 which is used to control the amount of stripping gas entering 320. The basis of setting this flow rate will be discussed herein after

Stream 342, the overhead vapors of 320, is comprised of the water and smaller amount of remaining dissolved CO₂ from the rich TEG solution as well as the CO₂ and a small amount of water contained in the stripping gas as well as a small amount of soluble and entrained TEG, have their pressure increased in vapor recovery unit compressor 344. This provides 346 a sufficient pressure head to be cooled in 348 to a temperature that utility system can provide which will result in a significant water dropout in 350 before passing through valve 352 which may help to control the back pressure of 348 before 354 is combined with the feed gas 220 as previously described.

This circuit from 342 to 354 recycles CO₂ back into the from end of the process to allow for further processing preventing a significant amount of CO₂ from leaving the system.

The majority of 298 is passed through stream 356 to a fourth stage of compression 358 which would be typically needed to compress the dehydrated CO₂ 360 to the final required pressure before being cooled in cooler 362 and before the final dehydrated CO₂ stream is passed to a transport/disposal step. Note in this case there should be a negligible amount of liquid in the suction of 358 as the gas stream is dehydrated, also 362 may shift the process stream to the liquid or dense phase which is advantageous transport/disposal.

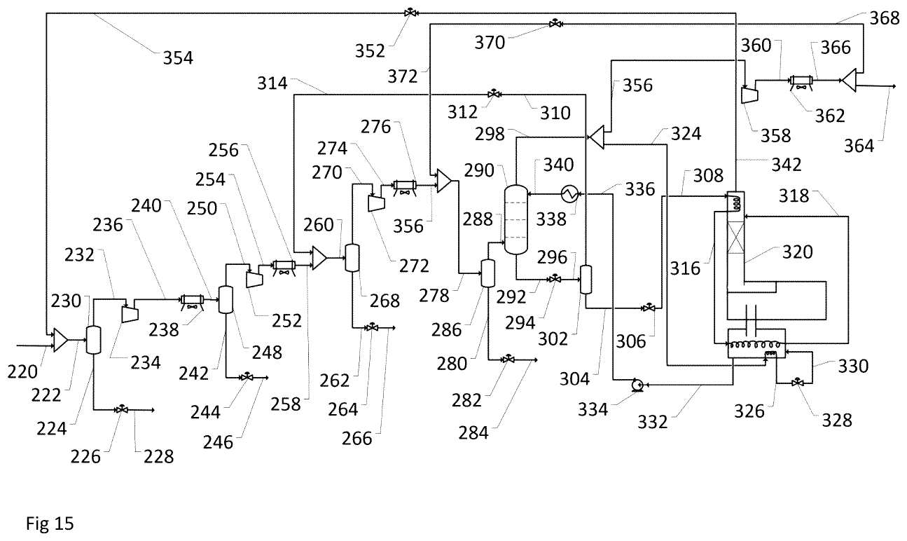

Referring now to FIG. 15, a TEG dehydration process is depicted with high pressure recycle.

The feed stream that is to be compressed and dehydrated is 220. This stream is mixed with a recycled stream 354 from the overhead of the TEG regenerator (the details of which will be described subsequently). The combined 222 flows into separator 230 which separates the vapor and liquids that are contained in the combined stream.

The liquids stream 224 passes through valve 226 as noted in FIG. 14 and then to stream 228.

The vapor stream 232 passes to the first stage of compression 234 to increase the pressure and temperature of the fluid exiting the compressor in stream 236 then passing into a cooler 238.

Stream 240 flows into separator 248. The liquids stream 242 passes through valve 244 and then to stream 246 which represents disposal or further handling of the liquids.

The vapor stream 250 passes to the second stage of compression 252 which exiting as stream 254 subsequently cooled at 256.

The cooled stream 258 is mixed with 314 to form a combined stream 260 which flows into separator 268 for separating the vapor and liquids that are contained in the stream.

The liquids stream 262 passes through valve and then to stream 266.

The vapor stream 270 passes to the third stage of compression 272 exiting the compressor as stream 274 with cooling at 276.

Stream 356 is mixed with the stream 372 which comes from flashing a high pressure resulting in a significantly lower temperature than would otherwise be available from 276. The resulting stream 278 contains an increased amount of liquid water and is significantly colder than what is seen in the same point in FIG. 14.

Stream 278 flows into separator 286 and undergoes treatment as mentioned in FIG. 14.

The vapor 288, which is now significantly colder with substantially less water compared to the same stream in FIG. 14, passes into the TEG Absorber contactor 290 as the vapor feed which will ultimately be contacted by a lean (in water) TEG solution. This enters the 290 via stream 340. Within 290 there are contacting devices such as trays or packing to facilitate the mixing of the descending liquid with the ascending vapor which will selectively remove water from the vapor by absorbing it into the liquid.

The modified properties of 288 have several key advantages which include: the requirement for significantly less TEG circulation 340 due to smaller amount of water to be removed and the need for a significantly less pure lean TEG solution because of the cooler temperatures at the overhead of contactor 290 whose equilibrium will play a significant role in the resulting water content in stream 298. Further, there is the potential to have a lower solubility of TEG in 298 and the lower temperature over all in contactor 290 provides the potential to effectively use a less costly material such as carbon steel vs. stainless steel due to the lower temperatures and a reduced corrosion potential.

The dehydrated vapor stream leaves contactor 290 as stream 298 and the rich (in water) TEG solution exits as stream 292. Stream 292 passes through valve 294 which acts as a level controller for the sump of 290 and drops the pressure of the stream to the second stage suction pressure found in 268 this will result in a significant amount of CO₂ which is dissolved in the TEG solution flashing from the liquid in stream 296 and then enters 302.

The vapor 310 from 302 flows through valve 312 (which can be used to help control the back pressure of 302) to stream 314 which is combines with 258 as previously mentioned. Due to the reduced circulation of 340, it is contemplated that the flow rate of 310 will also be significantly reduced. The recycling of the vapor from 302 prevents the loss of CO₂ from the overall system.

The liquid stream 304 leaving 302 passes through valve 306 which can be used to control the level in 302 as stream 308 which then passes into heat exchanger which removes heat from the overhead vapors of TEG regenerator 320. This acts to both provide some preheating to the rich TEG as well as providing a cooling to the overhead vapors providing some condensation and reflux to 320. Upon leaving this heat exchange 316 section, the partially heated rich TEG passes through a second heat exchange section which exchanges heat with the hot regenerated TEG in the accumulator below the TEG reboiler. This will both further preheat the rich TEG before entering the TEG regenerator 320 in stream 318 which acts to recover heat from the system and help to minimize the total heat input, and also to slightly cool the lean TEG that was just regenerated before being recirculated for use in 290.

Upon entering 320, the rich TEG stream will contact vapors generated in the lower part of the regenerator in the reboiler. This contact is facilitated with a contacting device such as trays or packing. The vapors will be comprised of more volatile components such as water and CO₂ and will concentrate as they move up the tower. This elevates the TEG concentration.

The stripping gas is split from the dehydrated gas stream 298 and passes through stream 324 before passing through a heat exchange section where the stripping gas is preheated through heat exchange with the hot regenerated TEG in the accumulator.

The preheated stripping gas 326 then flows through valve 328 used to control the amount of striping gas entering 320.

The requirement of a less pure lean TEG stream also allows the pressure of 320 to be increased while still not exceeding the maximum temperature limit of the TEG solution.

The ability to run 320 at a higher pressure allows 342 the overhead vapors which is comprised of the water and smaller amount of remaining dissolved CO₂ from the rich TEG solution as well as the CO₂ and small amount of water contained in the stripping gas (if used) as well as a small amount soluble and entrained TEG to flow through valve 352 which may help to control the back pressure of 342 before 354 is combined with the feed gas 220 as previously described. This circuit from 342 to 354 recycles CO₂ back into the from end of the process to allow for further processing preventing a significant amount of CO₂ from leaving the system.

In this example, the reduced flowrate and total amount of water that needs to be removed by the TEG absorption unit also for the removal of cooling in path of 342 to 354 since the temperature increase when 254 mixed with stream 220, will be minor given the large difference in the relative flow rates. The majority of 298 is passed through stream 356 to a fourth stage of compression 358 which would be typically needed to compress the dehydrated CO₂ 360 to the final required pressure for before being cooled in cooler 362 before the stream 366 is passed to a splitter where the majority of the flow passes to transport/disposal 364.

The other branch of splitter 366 feeds into stream 368 which passes through valve 370 the flow through which is used to control the temperature of 278 at the desired temperature after being mixed with stream 356. Valve 370 provides a significant pressure drop and because of the nature of the composition of 368 there is a significant temperature reduction.

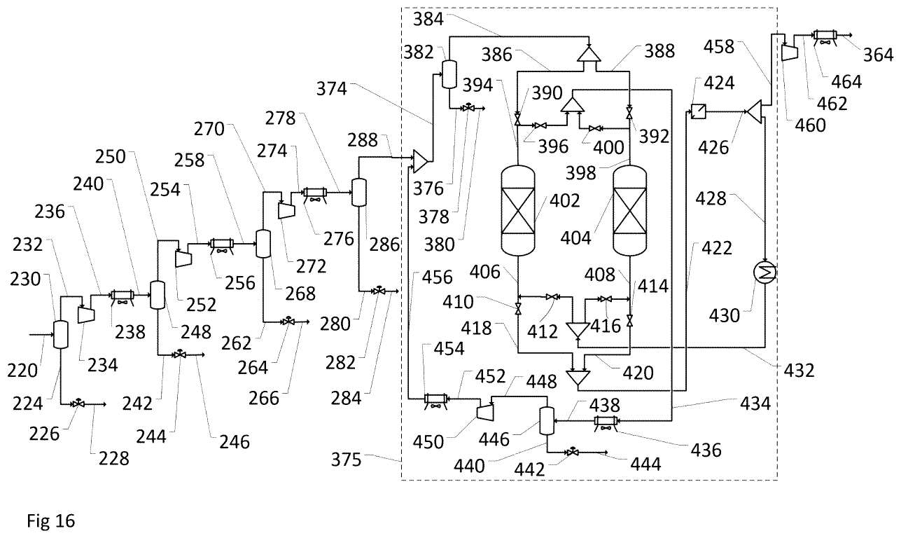

Turning now to FIG. 16, illustrated is a conventional adsorption dehydration process.

As with the previous examples, the feed stream that is to be compressed and dehydrated is 220 flows into separator 230. The liquids stream 224 pass through valve 226 and then to stream 228 which represents disposal or further handling of the liquids.

The vapor stream 232 passes to the first stage of compression 234 which increase the pressure and temperature of the fluid which exits the compressor in stream 236 which then passes into a cooler 238 which cools the stream. This cooling is necessary as noted in respect of FIG. 15.

Stream 240 flows into separator 248 which separates the vapor from liquids that are contained in the stream. The liquids stream 242 pass through valve 244 which could act as a level control valve and then to stream 246 which represents disposal or further handling of the liquids.

The vapor stream 250 passes to the second stage of compression 252 to increase the pressure and temperature of the fluid which exits the compressor in stream 254 and then passes into a cooler 256.

The cooled stream 258 flows into separator 268 which separates the vapor from and liquids that are contained in the stream. The liquids stream 262 pass through valve 264 to steam 266 which represents disposal or further handling of of liquids.

The vapor stream 270 passes to the third stage of compression 272 to increase the pressure and temperature of the fluid exiting the compressor in stream 274. This then passes into a cooler 276.

Stream 278 flows into separator 286. The liquids stream 280 pass through valve 282 and then to stream 284 which represents disposal or further handling of the liquids.

The vapor 288 is mixed with 456 an intermittent regeneration stream that contains the water from the regenerated adsorption bed as the base adsorption gas. The highlighted box labeled 375, represents a typical generic adsorption process the description of which follows.

Combining 288 and 456 results in 374 which may contain liquids in the form of condensed liquids from the cooled intermittent regeneration stream and or entrained liquid.

Stream 374 flows into separator 382. The liquids pass through stream 376 valve 378 which could act as a level control valve and then to stream 380 which represents disposal or further handling of the liquids.

The vapor 384, which is the stream that will pass through the adsorption bed for conditioning, comes to a splitter that will pass the entire flow to either 386 or 388 depending on which bed (402 or 404) is in adsorption mode. For the purposes of this description it is assumed that 402 is in adsorption mode and 404 is in regeneration mode, as such 384 is split to 386 by opening valve 390 and shutting valve 396 allowing the stream to flow to 394 and enter the top of the adsorption column 402 with the flow proceeding downward through an adsorbent media (such as a silica gel or mole sieve) that selectively removes water from the process stream by having it selectively be adsorbed on this media.

Upon leaving 402, the process stream 406 will contain the desired or lower content of water the flow proceeds to 418, since valve 410 will be open and 412 is closed, 418 proceeds to a mixer where it may be combined with 420. However, in this scenario, flow is zero so 422 would be comprised of the stream 418.

422 passes through 424 which may be a dust filter to remove any adsorbent media that may have carried over in the treated gas. Once leaving 424 the majority of 426 is passed through stream 458 to a fourth stage of compression 460 which would be typically needed to compress the dehydrated CO₂ 458 to the final required pressure before being cooled in cooler 464.

The final dehydrated CO₂ stream is passed to a transport/disposal step 364. Note in this case there should be a negligible amount of liquid in the suction of 458 as the gas stream is dehydrated. Further, 464 may shift the process stream to the liquid or dense phase which is advantageous for transport/disposal.

The other path that 426 could take would be an intermittent flow during the regeneration of an adsorption bed in which case a portion of the dried gas would be drawn to flow to 428 which then has it temperature increased with 430, which provides the required heat to regenerate the bed and must account for the heating of the bed media and vessel as well as to reverse the heat of adsorption of water.

With an sufficiently high temperature 432, proceeds to the splitter and passes to 408 by having valve 416 open and valve 414 and 412 closed and then enters the bottom of 404 where the temperature of the vessel and adsorbent media is gradually warmed over a predetermined amount of time to sufficiently remove water from the bed after which point the heating provided by 430 is turned off with the flow still in place in order to sufficiently cool the bed and vessel in preparation for switching to adsorption mode again.

Upon leaving 404, the process stream flows through 398 then through valve 400 which is open while valve 392 is closed before proceeding to 434 which may be cooled by 436 to condense water removed in the regeneration process and to cool the stream before having its pressure boosted by a compressor.

Stream 438 flows into separator 446 for separating the vapor from and liquids contained in the stream. The liquids pass through stream 440 valve 442 which could act as a level control valve and then to stream 444 which represents disposal or further handling of the liquids.

The vapor stream 448 passes to compressor 450 exiting the compressor in stream 452 then passing into a cooler 454 which cools the stream. This cooling may to drop out of liquid water in 456 which would be mixed with 288 and being part of the total gas to be treated in 374. When the adsorbing bed 402 cycles to regeneration and the regenerated bed 404 switches to adsorption the valves that were previously noted to be open would be closed and the valves that were noted to be closed would be opened.

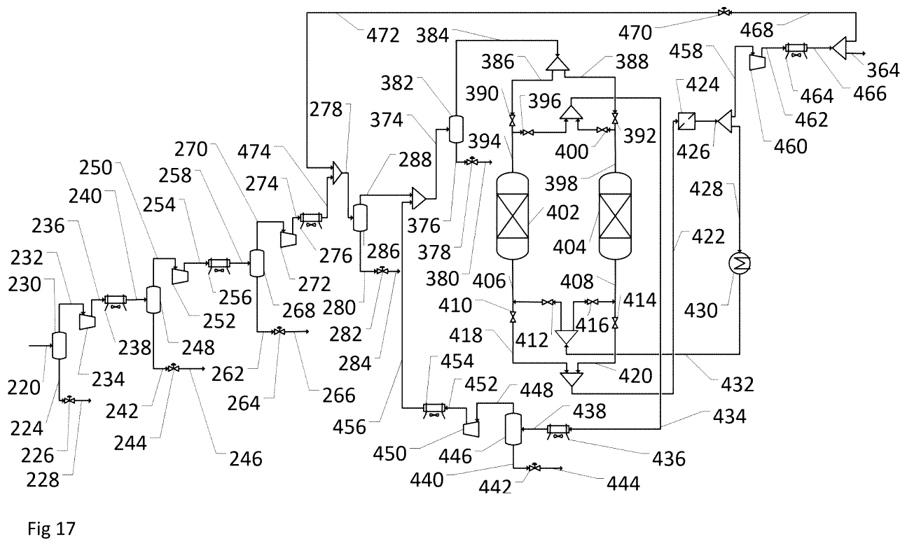

FIG. 17 illustrates an adsorption dehydration process with high pressure recycle.

Common numerals represent common operations as referenced earlier.

In this Figure, the vapor stream 270 passes to the third stage of compression 272 which increases the pressure and temperature of the fluid which exits the compressor in stream 274 which then passes into a cooler 276 which cools the stream 474.

Stream 474 is mixed with the stream 472. The resulting stream 278 contains an increased amount of liquid water and is significantly colder than what is seen in the same point in FIG. 16.

Stream 278 flows into separator 286. The liquids pass through stream 280 passes through valve 282 which could act as a level control valve and then to stream 284 which represents disposal or further handling of the liquids.

The vapor 288, which is now significantly colder with substantially less water compared to the same stream in FIG. 16 and is mixed with 456 an intermittent regeneration stream that contains the water from the regenerated adsorption bed as the base adsorption gas.

Combining 288 and 456 results in 374 which may contain liquids in the form of condensed liquids from the cooled intermittent regeneration stream and or entrained liquid. Stream 374 flows into separator 382. The liquids pass through stream 376 valve 378 which could act as a level control valve and then to stream 380 which represents disposal or further handling of the liquids.

The vapor 384 which is the stream that will pass through the adsorption bed for conditioning comes to a splitter that will pass the entire flow to either 386 or 388 depending on which bed (402 or 404) is in adsorption mode. For the purposes of this description it is assumed that 402 is in adsorption mode and 404 is in regeneration mode, as such 384 is split to 386 by opening valve 390 and shutting valve 396 allowing the stream to flow to 394 and enter the top of the adsorption column 402 with the flow proceeding downward through an adsorbent media (such as a silica gel or mole sieve) that selectively removes water from the process stream by having it selectively be adsorbed on this media.

The size of the adsorption bed will be determined by the total amount of water to be capture for a predetermined cycled time and typical design criteria based on the chosen media and required level of water removal.

Upon leaving 402, the process stream 406 will contain the desired or lower content of water the flow proceeds to 418. Since valve 410 will be open and 412 closed, 418 proceeds to a mixer where it may be combined with 420. In this scenario flow is zero and stream 422 would be comprised of stream 418. Stream 422 passes through 424 which may comprise a dust filter to remove any adsorbent media that may have carried over in the treated gas.

Once leaving 424, the majority of stream 426 is passed through stream 458 to a fourth stage of compression 460 typically needed to compress the dehydrated CO₂ stream 458 to the final required pressure for before being cooled at 464 and before the stream 466 is passed to a splitter where most of the flow passes to transport/disposal 364.

The other branch of splitter 466 stream passes into stream 468 which passes through valve 470 the flow through which is stream 472 and used to control the temperature of 278 at the desired temperature after being mixed with stream 474.

Valve 470 provides a significant pressure drop and because of the nature of the composition of 468, there is a significant temperature reduction. Note in this case there should be a negligible amount of liquid in the suction of 458 as the gas stream is dehydrated, also 464 may shift the process stream to the liquid or dense phase which is advantageous transport/disposal.

The other path that 426 could take would be an intermittent flow during the regeneration of and adsorption bed in the in which case a portion of the dried gas would be drawn to flow to 428 which then has its temperature increased with 430. This provides the required heat to regenerate the bed and must account for the heating of the bed media and vessel as well as to reverse the heat of adsorption of water.

With a sufficiently high temperature 432 proceeds to the splitter and passes to 408 by having valve 416 open and valve 414 and 412 closed and then enters the bottom of 404 where the temperature of the vessel and adsorbent media is gradually warmed over a predetermined amount of time to sufficiently remove water from the bed. Subsequently, the heating provided by 430 is turned off with the flow still in place to sufficiently cool the bed and vessel in preparation for switching to adsorption mode again.

Upon leaving 404 the process stream flows through 398 then through valve 400 which is open while valve 392 is closed before proceeding to 434 which may be cooled by 436 which may condense water removed in the regeneration process and also cool the stream before having its pressure boosted by a compressor.

Stream 438 flows into separator 446. The liquids pass through stream 440 valve 442 which could act as a level control valve and then to stream 444 which represents disposal or further handling of the liquids.

The vapor stream 448 passes to compressor 450 and exits the compressor in stream 452 which then passes into a cooler 454. This cooling may drop out liquid water in 456 which would be mixed with 288 and being part of the total gas to be treated in 374. When the adsorbing bed 402 cycles to regeneration and the regenerated bed 404 switches to adsorption the valves that were previously noted to be open would be closed and the valves that were noted to be closed would be opened.

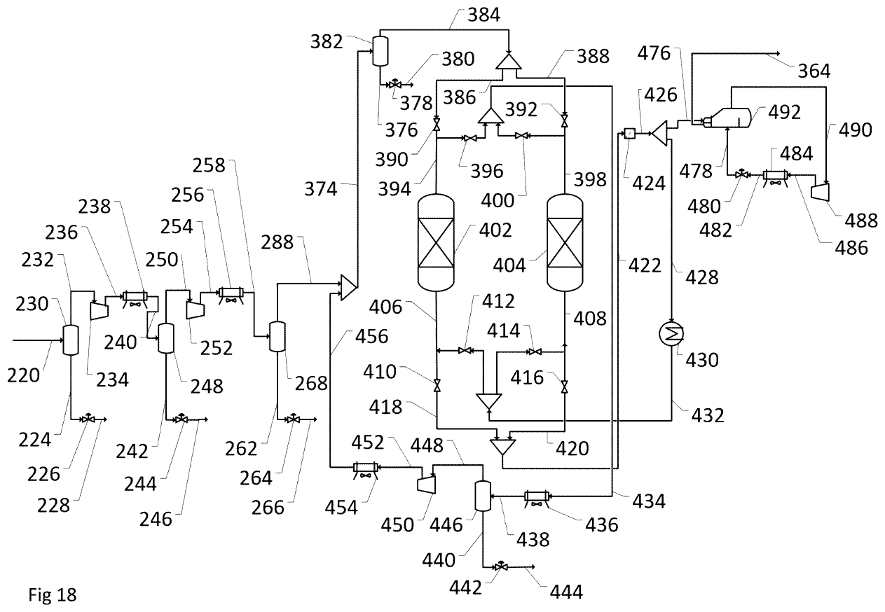

FIG. 18 represents a conventional CO₂ dehydration and liquefaction process.

Similar numerals are representative of similar operations referenced in the previous Figures.

In the Figure, the vapor 288 is mixed with 456 an intermittent regeneration stream that contains the water from the regenerated adsorption bed as the base adsorption gas.

Combining 288 and 456 results in 374 which may contain liquids in the form of condensed liquids from the cooled intermittent regeneration stream and or entrained liquid.

The vapor 384 which is the stream that will pass through the adsorption bed for conditioning comes to a splitter that will pass the entire flow to either 386 or 388 depending on which bed (402 or 404) is in adsorption mode. For the purposes of this description it is assumed that 402 is in adsorption mode and 404 is in regeneration mode, as such 384 is split to 386 by opening valve 390 and shutting valve 396 allowing the stream to flow to 394 and enter the top of the adsorption column 402 with the flow proceeding downward through an adsorbent media (such as a silica gel or mole sieve) that selectively removes water from the process stream by having it selectively be adsorbed on this media.

The size of the adsorption bed will be determined by the total amount of water to be capture for a predetermined cycled time and typical design criteria based on the chosen media and required level of water removal.

Upon leaving 402 the process stream 406 will contain the desired or lower content of water the flow proceeds to 418 since valve 410 will be open and 412 is closed 418 proceeds to a mixer where it may be combined with 420 however in this scenario flow is zero so 422 would be comprised of 418.

Stream 422 passes through 424. Once leaving 424 the majority of 426 is passed through stream 476 which then passes through a chiller 492 where an external refrigeration unit provides sufficient cooling to fully condense the dehydrated CO₂ stream 364 at a lower pressure for the purposes transporting the CO₂ for disposal.

The refrigeration process in this example is represented by a single propane refrigeration loop. Numeral 484 represents a condenser that functions to cool the refrigerant stream after compression as well as to fully condense stream 482. Stream 482 is then flashed over valve 480 to a pressure using the JT principle to provide a temperature sufficient to act as a driving force in the chiller 492. Once stream 478 enters the shell side, the chilled two phase stream will be vaporized by taking heat from stream 476.

The vaporized stream leaving 492, 490 then flows into compressor 488 which provides pressure require by the JT valve 480.

The other path that 426 could take would be an intermittent flow during the regeneration of and adsorption bed in the in which case a portion of the dried gas would be drawn to flow to 428 which then has it temperature increased with 430, which provides the required heat to regenerate the bed and must account for the heating of the bed media and vessel as well as to reverse the heat of adsorption of water.

With an sufficiently high temperature, 432 proceeds to the splitter and passes to 408 by having valve 416 open and valve 414 closed and then enters the bottom of 404 where the temperature of the vessel and adsorbent media is gradually warmed over a predetermined amount of time to sufficiently remove water from the bed after which point the heating provided by 430 is turned off with the flow still in place in order to sufficiently cool the bed and vessel in preparation for switching to adsorption mode again.

Upon leaving 404 the process stream flows through 398 then through valve 400 which is open while valve 392 while before proceeding to 434 which may be cooled by 436 which may condense water removed in the regeneration process to cool the stream before having its pressure boosted by a compressor.

Stream 438 flows into separator 446 which separates the vapor from and liquids that are contained in the stream. The vapor stream 448 passes to compressor 450 and exits the compressor in stream 452, then passing into cooler 454. This cooling may drop out liquid water in 456 which would be mixed with 288 and being part of the total gas to be treated in 374. When the adsorbing bed 402 cycles to regeneration and the regenerated bed 404 switches to adsorption the valves that were previously noted to be open would be closed and the valves that were noted to be closed would be opened.

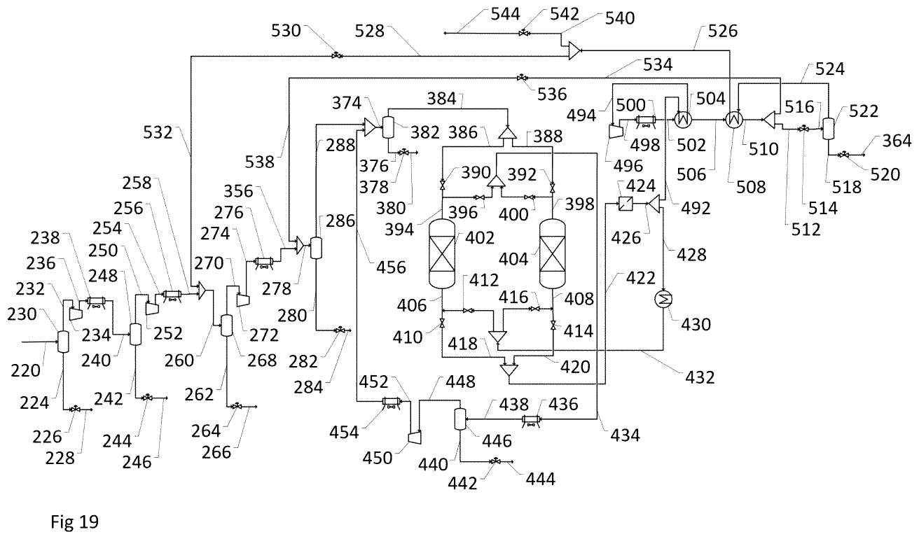

Referring now to FIG. 19 illustrated is a circuit for combined high pressure recycle and liquefaction.

Similar numerals are representative of similar operations.

Once leaving 424 the majority of 426 is passed through stream 492 and then passes through heat exchanger 504 before passing to 494 to be compressed by a fourth stage of compression 496 used to provide additional pressure that will be used in a subsequent process to provide a liquified low pressure CO₂ stream.

The stream 498 leaving 496 is cooled with a utility cooler 500 before stream 502 is passed into the other side of 504 where the cold temperatures of 492 can be used to cool 506. This is done before passing into heat exchanger 508 where 510 is cooled prior to being split between 534 or 512. Stream 534 is a high pressure recycle as described in Mckay et al., the flow rate of which is set by adjusting 536 control to temperature of the mixed stream 278 which drops a substantial amount of water out as a liquid and provides a smaller quantity of water to be removed by the adsorption bed and also condition the stream by cooling it to provide an enhanced performance of the adsorbent media in 402 and 404.

Following on from the other potential split flow path from 510, 512 is reduced in pressure over 514 to a pressure that aligns with a pressure slightly higher than the desired transportation pressure. This achieves a two phase stream will be produced at the necessary storage temperature in 516 which is separated using separator 522. The separated liquid flows to 518 and passes through valve 520 which may be used as a level control valve resulting in 364 which is the liquified CO₂ for transportation.

The vapor stream 524 is passed through 508 to provide cooling to 510. This provides a favorable condition before being flashed in valves 536 and 512 which required less flow in 534 and 512 to obtain the desired temperature in the case of 534 and to decrease the vapor fraction in the case of 512.

526 flows from 508 into a splitter that may act as a purge for non-condensable in the system (which will tend to concentrate in 524) by opening valve 542 allowing flow through 540 and 544 to further processing or disposal.

Most of the flow will pass through 528 valve 530 and 532 to be mixed with 356 to feed back into 286 which is the third compressors stage suction optimized to match the required transportation pressure to help reduce the total require compression duty.

The other path that 426 could take would be an intermittent flow during the regeneration of and adsorption bed in the in which case a portion of the dried gas would be drawn to flow to 428 which then has it temperature increased with 430, which provides the required heat to regenerate the bed and must account for the heating of the bed media and vessel as well as to reverse the heat of adsorption of water.

With an sufficiently high temperature, stream 432 proceeds to the splitter and passes to 408 by having valve 416 open and valve 414 closed. It then enters the bottom of 404 where the temperature of the vessel and adsorbent media is gradually warmed over a predetermined amount of time to sufficiently remove water from the bed. Subsequently, the heating provided by 430 is turned off with the flow still in place in order to sufficiently cool the bed and vessel in preparation for switching to adsorption mode again.

Upon leaving 404, the process stream flows through 398, through valve 400 which is open while valve 392 is closed before proceeding to 434 which may be cooled by 436 to condense water removed in the regeneration process. This also cools the stream before a pressure boost by a compressor.

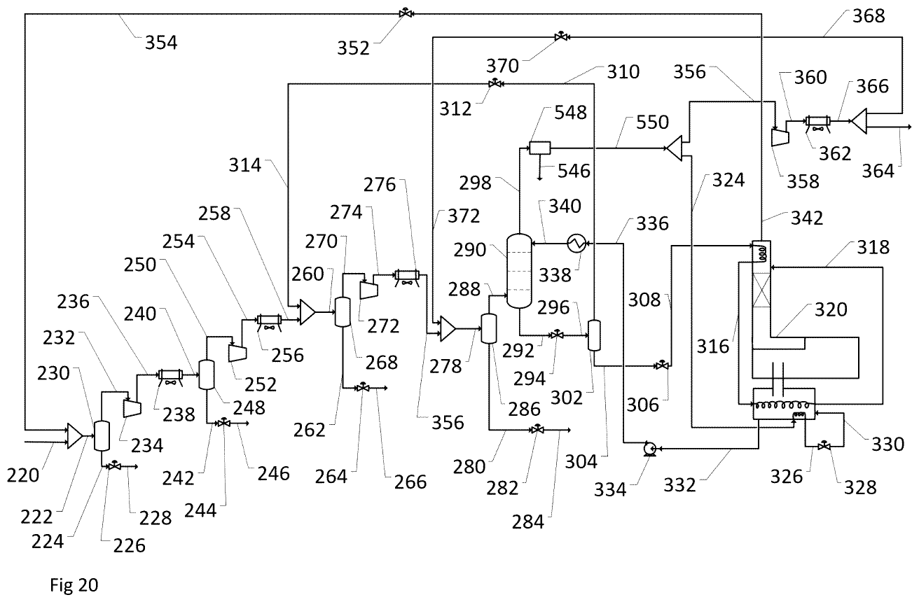

FIG. 20 has the same basic function as was previously described in FIG. 15 with the addition of 548. This represents an additional device or process that is designed to remove additional components in 546 from 298 before passing the further conditioned stream 550 in through the remaining process as was done previously.

The addition of 548 is based on the fact that water has largely been removed from the process and the temperature of the stream would still be substantially cooler than it would otherwise have been using a cooling device such as 276.

Both things have the potential to provide an advantageous condition to improve the efficiency of process 548.

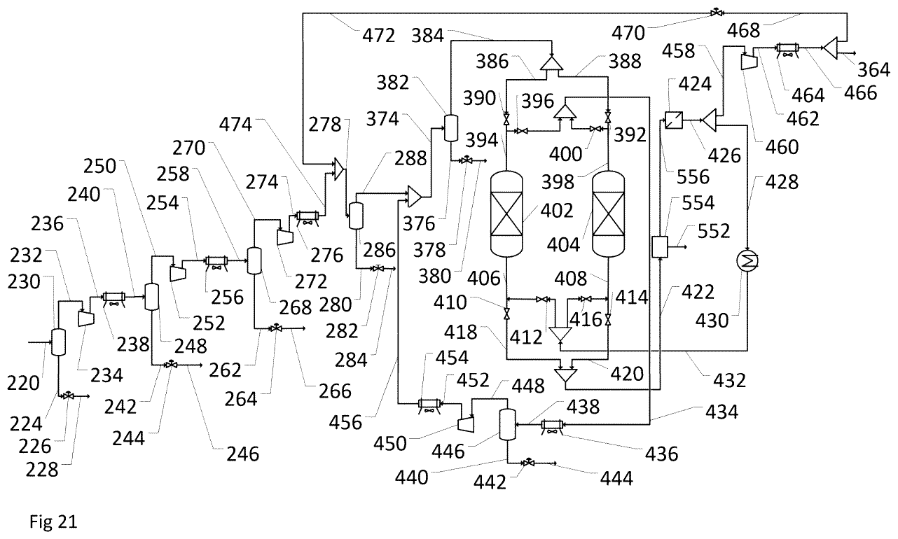

FIG. 21 has the same basic function as was previously described in FIG. 17 with the addition of 554 which represents an additional device or process that is designed to remove additional components in 552 from 422 before passing the further conditioned stream 556 in through the remaining process as was done previously. The decision to add 554 to this point in the process is based on the fact that water has largely been removed from the process and the temperature of this stream is still substantially cooler than it would otherwise have been using a cooling device such as 276. Both of these things have the potential to provide an advantageous condition to improve the efficiency of process 554.

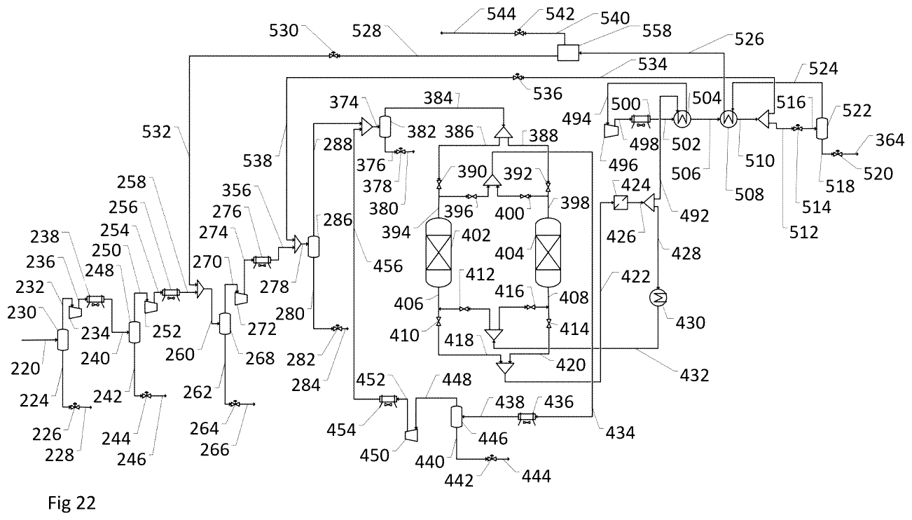

FIG. 22 has the same basic function as was previously described in FIG. 19 with the addition of 558 which represents an additional device or process that is designed to remove selected components in 540 from 526 before passing the further conditioned stream 528 in through the remaining process as was done previously.

The decision to add 558 to this point in the process is based on the fact non condensable components will tend to concentrate in 524 by the nature of the separation taking place in 522 and being able to selectively remove these components from 526 will provide the benefit that these higher concentrations tend to improve the effectiveness of the separation of these components by 558.

In addition, the selective removal of non-condensable components from 526 with 558 would act to reduce the total flow rate of this stream as well as the total purge rate 544 as the total amount of non-condensables present in the 220 must equal the amount of non condensables leaving the system largely in 364 and 544 plus any minor amount in the handled liquid streams. This is advantageous to improve the efficiency of process 554.

Having the unit operations detailed, reference will now be made to some specific scenarios to further elucidate the effectiveness of the technology.

The detailed analysis of a given acid gas conditioning and associated upstream and downstream processes allows for synergized combination of processes to provide a myriad of improvements. The following three scenarios illustrate how this can be done with three increasingly more stringent specifications for conditioning a wet CO₂ stream.

These consider a feed stream 100% CO₂ (on a dry basis) that is saturated with water at 120 F and 25 psia with a flow rate of 68.8 MMSCFD which is represented by 220 in FIGS. 14 through 22.

The following three scenarios will be presented: 5 lb H2O/MMSCF, less than 10 ppm mol water and liquified CO₂ for low pressure transport.

These specifications are representative of the types of water contents and transportation requirements that are being considered by operators.

5 lbH2O/MMSCF-TEG Dehydration

The conventional approach to dehydrate this stream to this level of dryness would be to use a TEG (triethylene glycol) based absorption process. A TEG unit could be standalone, provided the incoming feed stream is at pressure, but more typically it would be located within a compression train for CO₂ or acid gas systems, as these are typically generated at low pressure. FIG. 14 shows where a TEG dehydration unit (box 289) may be situated in the overall compression and conditioning process.

The additional connections from the TEG process to the first stage of the compression process will be discussed in greater detail herein after.

Conventionally, the use of stripping gas 324 is used to further decrease the water content in the lean TEG while still maintaining a maximum TEG regenerator reboiler temperature (such as 400° F.). The regenerator temperature must be limited to prevent a thermal degradation of the TEG solution. Treated gas is used as the stripping gas and it is typically fed at a rate that is ratioed with the lean TEG circulation rate. The value of the stripping gas to solvent ratio is set based on the desired water content in the treated gas for a given set of conditions. This allows adjustment to the concentration of the lean TEG (332). This stripping gas will ultimately end up in the regenerator overheads which also contains the water removed from the regeneration process as well as smaller quantities of other dissolved gases and entrained TEG 342. This gas may be vented, resulting in a not insignificant amount of CO₂ being released to the environment which is often counter to the overall objective of the larger facility.

As such, a vapor recovery unit (VRU) comprised of a compressor and associated heat exchange and separation equipment (344, 348, 230) can be installed to recycle this stream to a lower pressure stage of the compressor. Any water condensed in this process would be handled in the low pressure stages of separation. The addition of the VRU not only adds to the total number of pieces of equipment and CAPEX, OPEX and maintenance costs of the VRU, but it will also increase the required power of all the compression stages subsequent to the injection point of the VRU gas attributed to the recycled CO₂.

The function of the conventional TEG unit has been thoroughly investigated however, there are numerous key improvements and advantages by combining two conditioning processes in series as demonstrated in the following sections.

5 lbH2O/MMSCF Combination of Processes

With reference to FIG. 15, it can be seen that a recycle stream (368) of the cooler, high pressure, dehydrated gas from stage X is recycled and mixed with the cooled gas from compressor stage 3 (272) as is detailed in Mckay et al, supra. The recycled gas is expanded and as a result, cools the stream, and when mixed with Stage 3 (272) gas will cool the combined stream and form a water liquid phase which is then removed in the vessel. This will result in a combined stream that has substantially had its water content removed via bulk separation and reduces the TEG unit load to only trim water removal to required specifications. This allows for a reduction in the total required TEG circulation rate to remove water from the gas stream. This stream is also now at a temperature of 60° F. (compared to a temperature of 120° F. in the conventional TEG scheme), which is then fed into the TEG Absorber 290.

The lower temperature improves absorption effectiveness as discussed previously, which allows for a lower quality lean TEG stream. A lower quality lean TEG stream reduces regeneration energy requirements without the need for stripping gas and allows for regeneration to proceed at an elevated pressure, resulting in the elimination of a VRU unit since the pressure of the regenerated gas could then align with first stage compressor suction pressure.

In toto, by combining these processes, trim and bulk water separation are completed in a manner that can more fully utilize the efficiency of both processes. The ability to adjust or control the conditions of the trim separation in the TEG unit provide the opportunity to utilize favourable equilibrium conditions and facilitate the removal of additional equipment, depending on the desired outcomes at a given facility. For example, if this system were to be installed in an existing dehydration unit, the addition of the recycle could extend the capacity range of the existing unit.

The following table highlights the benefit of combining conditioning processes. As will be evident, not only is the initial water content decreased due to the lower feed temperature of stream 288, but this also cascades into several key parameters that decrease the overall size and energy requirements for conditioning.

TABLE 1
FIG. 14 vs FIG. 15

| | FIG. | | | |
|---|---|---|---|---|
| | 14 | | 15 | |
| Stream 288 | 142.0 | lbH2O/ | 29.9 | lbH2O/ |
| Water Content | | MMSCF | | MMSCF |
| Stream 288 Total Water | 406.9 | lbH2O/h | 107.5 | lb H2O/h |
| Stream 288 Temperature | 119.6 | F. | 63.2 | F. |
| Stream 288 Pressure | 445.7 | psia | 445.7 | psia |
| Stream 298 Temperature | 125.6 | F. | 64.1 | F. |
| Stream 332 Pressure | 15.7 | psia | 24.8 | psia |
| Stream 332 TEG | 99.6 | wt % | 97.7 | wt % |
| Concentration | | | | |
| Stream 340 flow rate | 19.2 | US gal/h | 1.2 | US gal/h |
| Regenerator Duty | 549,052 | Btu/h | 116,334 | Btu/h |
| Stream 364 | 5 | lb H2O/ | 5 | lb H2O/ |
| Water Content | | MMSCF | | MMSCF |

| | | |
|---|---|---|
| Contactor Diameter | 66″ | 60″ |

### 10 ppm Adsorption

A second example of the application of a detailed analysis of how an existing dehydration unit could be improved will now be discussed.

In this scenario, the base case is the same prior in terms of the conditions-composition, flow, T and P, as is the required injection pressure. The only difference is the required level of dehydration as the water content specification in this case is 10 ppm. This tighter water specification necessitates the use of an adsorption based dehydration process.

FIG. 16 is representative of such an adsorption based process. This particular adsorption unit is a two bed Temperature Swing Adsorption (TSA) unit which has one vessel in adsorption mode with the other bed in regeneration/cooling/stand by cycle. In a TSA process, the regeneration is driven by warming the spent adsorbent bed, typically using a heated slipstream of the treated gas from the adsorbing bed. This will heat the vessel and bed medium but will also provide the driving force to release the adsorbate from the adsorbent. The regeneration cycle for a TSA is comprised of heating then cooling to ready the bed for the next adsorption cycle. The process of regeneration and the required heat is a significant source of the energy consumption in an adsorption unit and the significant portion of the emissions associated with these units. Generally speaking, the larger the unit required, the greater the energy required to regenerate the unit: The overall size of these units will be determined by the desired design cycle time and bed lifetime for a given flow rate and total amount of material to be removed. The adsorption process is similar for other types of adsorption units, such as Pressure Swing Adsorption (PSA), however in PSA, regeneration is completed via pressure rather than temperature swing.

Through a similar analysis the size of the adsorbent bed is largely determined by the flow and total amount of water to be removed. By placing two units in series, similar to the previously investigated system, the bulk of the water removal can be done with, for example the Mckay et al. process, supra, which lessens the total amount of water to be removed in the adsorbent bed, as shown in FIG. 17. This allows for a smaller overall adsorbent bed, as well as the subsequent regeneration requirements. In addition, the cooler feed temperature can have positive effects on the performance of the adsorbent material which could tend to decrease bed volume requirements for a given scenario.

From the outset, a greenfield design can take advantage of this. In retrofit applications, this approach can be used to debottleneck an adsorption process by removing some of the water load that the current beds cannot handle within the facility regeneration time and bed life requirements.

The following table highlights the benefit of combining conditioning processes. Not only is the initial water content decreased due to the lower feed temperature of Stream 288, but this also cascades into several key parameters that decrease the overall size and energy requirements for conditioning.

TABLE 2
FIG. 16 vs. FIG. 17

| | Stream | Stream | | | | Stream |
|---|---|---|---|---|---|---|
| | 288 | 288 | | | | 364 |
| | Water | Total | Stream | Regeneration | | Water |
| igure | Content | Water | 288 T | Requirements | Absorber Tower | Content |
| 16 | 121.43 | 387.2 | 105.7 F. | 16.0 hrs | Two (2) towers | <10 ppm |
| | lb H2O/ | lbH2O/h | | regeneration | 120″ ID × 24′-0″ | |
| | MMSCF | | | 24.0 | 2-⅝″ w.t., | |
| | | | | MMSCF/d | 110,356 lb ea. | |
| | | | | regen gas | 24 hrs | |
| | | | | 12.7 | adsorption | |
| | | | | MMBtu/hr | 146,300 lb 3A | |
| | | | | heater | sieve total | |
| 17 | 29.89 | 137.3 | 58 F. | 7.0 hrs | Two (2) towers | <10 ppm |
| | lb H2O/ | lbH2O/h | | regeneration | 96″ ID × 16′-0″ | |
| | MMSCF | | | 14.5 | 2-⅛″ w.t., | |
| | | | | MMSCF/d | 49,334 lb ea | |
| | | | | regen gas | 24 hrs | |
| | | | | 9.1 MMBtu/hr | adsorption | |
| | | | | heater | 54,890 lb 3A | |
| | | | | | sieve total | |

### Conventional Liquefaction

A third example of a detailed analysis of how an existing dehydration unit could be improved follows.

In this scenario, the base case is the same as noted above in terms of the inlet conditions-composition, flow, T and P, but the end use is a low pressure transport of liquid CO₂, which necessitates sub-zero temperatures. The water content will be determined by either specifications for transport or hydrate prevention but would be expected to be sufficiently low to require an adsorption based process.

FIG. 18 is representative of such a liquefaction process. The basic processes would entail compressing CO₂ to the nominal CO₂ transport pressure and additionally what is required to overcome pressure losses through adsorption and refrigeration.

Placing the dehydration process after compression takes advantage of the partial dehydration through compression and cooling and inherent improvement to adsorption at higher pressures. Once dehydrated, the CO₂ would pass through a chiller where it would be liquefied utilizing an external refrigeration unit.

By placing the first two units in series, similar to the previously investigated system, the bulk of the water removal can be done with the Mckay et al. process, supra, which lessens the total amount of water to be removed in the adsorbent bed, as shown in FIG. 19.

This allows for a smaller overall adsorbent bed, as well as the subsequent regeneration requirements. In addition, the cooler feed temperature can have positive effects on the performance of the adsorbent material which could tend to decrease bed volume requirements for a given scenario.

It has been determined that by adding compression stage, an opportunity to further leverage the behaviour of the acid gas to provide self-refrigeration as a basis to liquefy the stream is created, in addition to providing cooling to supplement bulk dehydration. The addition of these stages can be negligible compared with the addition of a separate utility refrigeration unit as the operation is integrally tied to the operation of the CO₂ compressor, and by removing the requirement for an additional refrigeration skid can potentially decrease the points of failure in the system.

The following table highlights the benefit of combining conditioning processes. The system shown in FIG. 19 results in a lower temperature and significant reduction in the total amount of water to be removed. This results in reduced vessel sizes, reduced regeneration requirements and a more efficient process.

TABLE 3
FIG. 18 vs FIG. 19

| | | | | | | Total |
|---|---|---|---|---|---|---|
| | Stream 288 | | | | Stream | Rotating |
| | Water | Stream 288 | Stream 288 | Stream 288 | 364 Water | Equipment |
| FIG. | Content | Total Water | Temperature | Pressure | Content | Duty |
| 18 | 253.7 lb | 731.0 lb | 100 F. | 196.3 psia | 0.1 lb H2O/ | 68.05 |
| | H2O/MMSCF | H2O/h | | | MMSCF | MMbtu/h |
| 19 | 18.36 lb | 102.5 lb | 42.8 | 562.9 psia | 0.1 lb H2O/ | 69.26 |
| | H2O/MMSCF | H2O/h | | | MMSCF | MMbtu/h |

In these scenarios, the ability to condition the feed temperature may be used to optimize the design; an example of this is shown in FIG. 20 where the process represented by 548 can take advantage of the conditioned nature of the stream as well as the lower temperatures.

In an absorption based process, secondary wash loops with an affinity to a given component could be added downstream or even within the same primary TEG dehydration system. Once again, this unit may be structured to utilize the same benefits as discussed previously.

In the course of combining two or more processes that focus on water dehydration, there is an opportunity to simultaneously remove additional components while taking advantage of the inherent benefits as previously described. For example, in an adsorption-based dehydration, additional media could be placed within the adsorption bed or be part of a secondary adsorbent bed process that could target the removal of these components, such as shown in FIG. 21.

Additional media targeting these components may be placed in 402 or 404 or and additional capture process could be placed downstream of the adsorber, such as the case with 554. The regeneration system in this case may require separate processing to manage the mass balance of these components.

In the case of liquefaction, there is the potential for additional conditioning steps based on separator 522 tending to concentrate non-condensables in the vapour space which can then be purged in 544 or selectively removed in process 558, such as shown in FIG. 22; noting the decrease in recycle and increase in flexibility for varying gas compositions to be liquified.

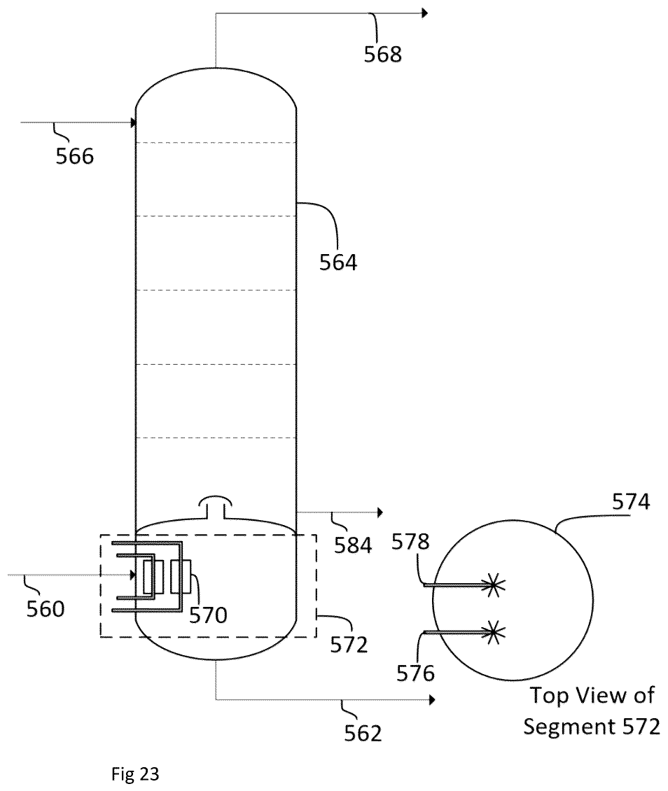

FIGS. 23 through 28 globally represent an absorber contactor which is used in a large number of process industries.

The stream to be treated, 560, enters the bottom of the absorber contactor 564 and passes into an integrated separator that will separate liquid 562 from vapor before it enters the bottom of the contacting section of the absorber. The contacting section may contain a contacting device such as packing or trays to facility the contact of vapor and liquid.

The lean solvent 566 is fed into the top of 564 where it proceeds to move down through the contacting section contacting the vapor that is moving up the tower. Such contact will facilitate the removal of the desired component to be removed from the vapor by being absorbed into the liquid, e.g. water, vapor in CO₂ being absorbed by a TEG solution. As the vapor reaches the top of the contacting section, it enters a disengagement zone which provides a volume to allow for entrained liquid droplet to separate from the exiting vapor. This may be assisted by an additional separation device, such as a mist eliminator.

The treated vapor leaves contactor in stream 568. As the liquid moves down 564, it will become rich in the component that is to be removed from the treated gas; for example, in a CO₂ dehydration application using TEG, the liquid at the bottom of the absorber contactor would be light in water compared to the lean solvent. The rich solvent would leave the contactor in stream 584 which is flow from a sump below the contacting section of 564.

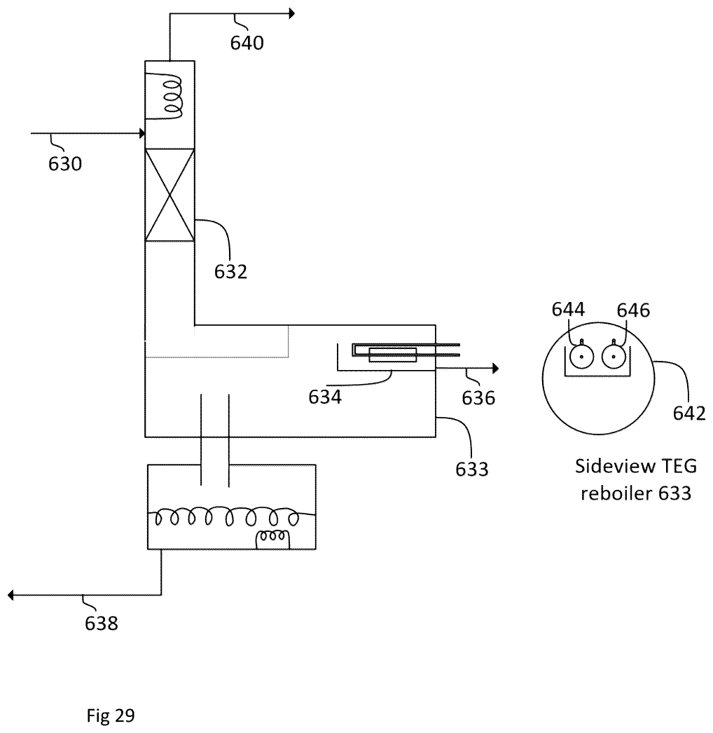

FIG. 29 shows a solvent regenerator which is used in a large number of process industries this configuration is indicative of a TEG Regenerator. The following is a general summary of the operation of the regenerator, a proposed enhancement is described herein after.

The rich solvent is feed to the top portion of the regeneration tower 632 above the contacting section which may comprise a contacting device, such as a packing or trays, to facilitate the contact between the liquid flowing down 632 and the vapor coming from the reboiler 633.

As the liquid flows down the contacting section and contacts the vapor, the relatively more volatile components will tend to be stripped from the liquid and enter the vapor phase regenerating the liquid.

Upon exiting the contacting section, the vapor passes through a heat exchanger coil which will remove heat from the vapor which will tend to condense less volatile components that are contained in the vapor with the regenerator vapor leaving the tower in 640. As the liquid leaves the contacting section, it enters the regenerator reboiler 633 to add heat into the system necessary to vaporize the material in the reboiler to be able to allow the regenerator to properly function. In the absence of a stripping gas (as described previously) or other enhanced regeneration process the reboiler will provide the final quality of the of the lean solvent. The liquid flows out of the reboiler and passes through an accumulator were stripping gas may be added, the lean solvent then leaves the regenerator in 638.

FIGS. 23 through 26 depict configurations where additional enhancements may be made to an absorption process, namely the selective cooling for purposes of further conditioning of a process stream through the condensation and/or freezing and selective removal of specific components. The specific configuration of the cooling device will be optimized for each scenario and may work to cool the entirety of the processed stream or to cool and remove a fraction of the specific component.

The following details many potential applications and benefits.

As an example, FIG. 23 illustrates the addition of cooling device 570 in the vapor space of the inlet separator portion 572 of absorber contactor 564.

This device may be cooled by the recycling of high pressure acid gas or other cooling medium (not shown) in order to cool the whole flow steam 560 or a portion of it allowing additional water to condense and or freeze to the cooling device 570 providing additional water removal/cooling.

In the situation where the design is to have water freeze to the cooling device, multiple cooling circuits 576 and 578 may be installed in order to have one or more in cooling service while one or more are in thawing service.

The heating may be provided through a heat medium in the same flow path as the cooling medium, external heat such as resistive heating or by turning off the cooling medium and having the surrounding material provide the heating. Provisions to include additional separation devices to the cooling devices such as extra channeling or membrane cladding may improve the performance of the devices.

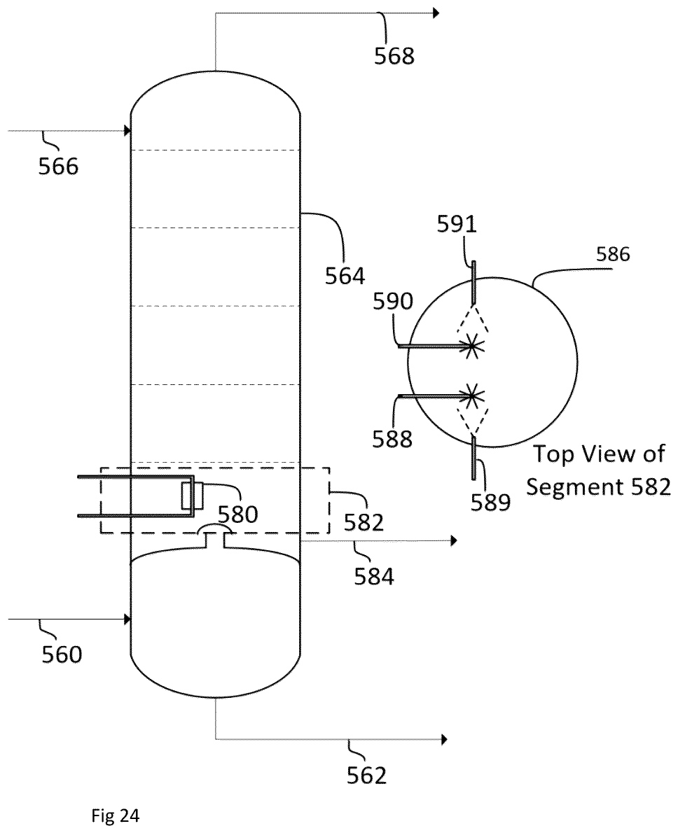

FIG. 24 depicts the addition of a cooling device in the rich liquid accumulation/vapor feed section 582 of the absorber contactor 564. Multiple circuits are envisioned for placement here and the cycle may be conducted in the same manner and for the same purpose as FIG. 23 with the additional option of using a spray of the absorbing solvent to help remove any frozen or condensed material on the cooling circuits. The resulting solvent introduced by the spray in 589, 591 coming from the cooling circuits 588, 590 may be collected and processed with the rich solvent 562.

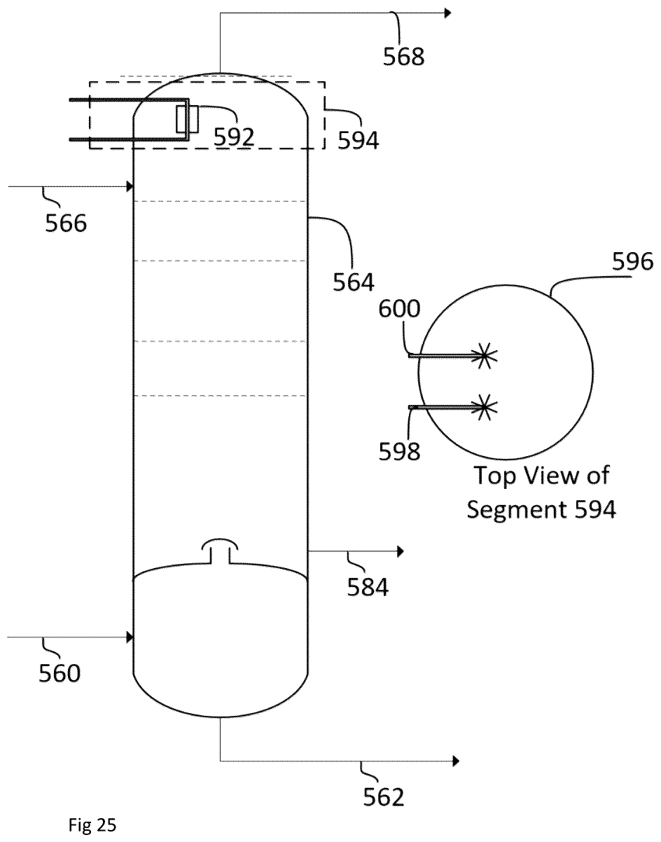

FIG. 25 illustrates the addition of cooling devices 592 to the disengagement zone above the contacting stages 594 zone above of the absorber contactor 564. In this application, the devices are primarily added to help capture solvent components that are either physically dissolved or entrained in the treated stream.

The design of the cooling devices 592 can be optimized to remove varying amounts of solvents. As with the other configuration, having multiple circuits 598, 600 in place and being able to cycle them in cooling and heating models will provide the flexibility to capture the solvents by freezing them on to the cooling device 598 and 600. The resulting capture solvent may be blended with the solvent circuit of the main process at a favorable point or handled separately.

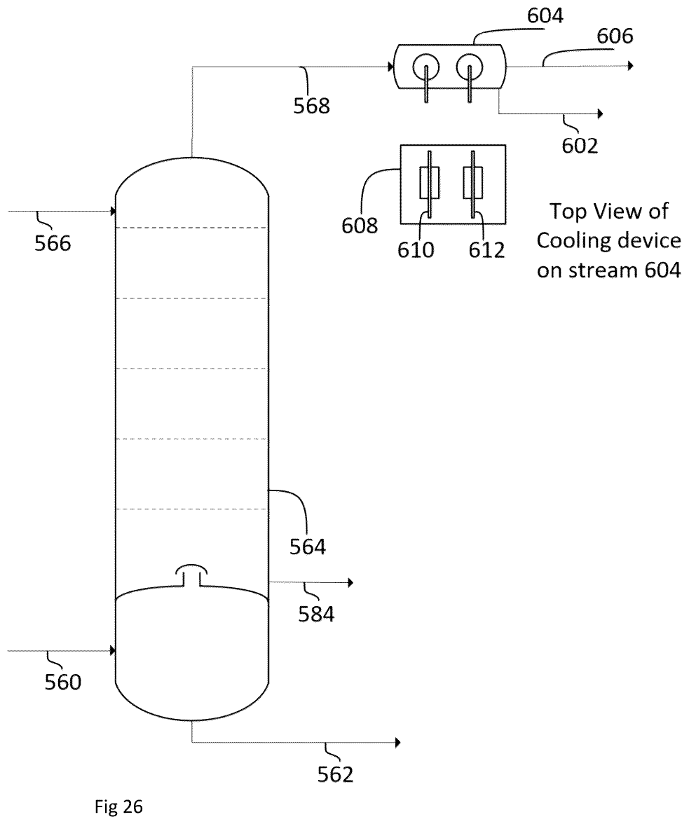

FIG. 26 illustrates the addition of cooling devices 604 to the treated stream 568 leaving the contactor 564. In this application, the devices are primarily added to help capture solvent components that are either physically dissolved or entrained in the treated stream 568.

The design of the cooling devices 604 can be optimized to remove varying amounts of solvents. As with the other configuration, having multiple circuits in place and being able to cycle them in cooling and heating models will provide the flexibility to capture the solvents by freezing them on to the cooling device 610 and 612. The resulting capture solvent may be blended with the solvent circuit of the main process at a favorable point or handled separately.

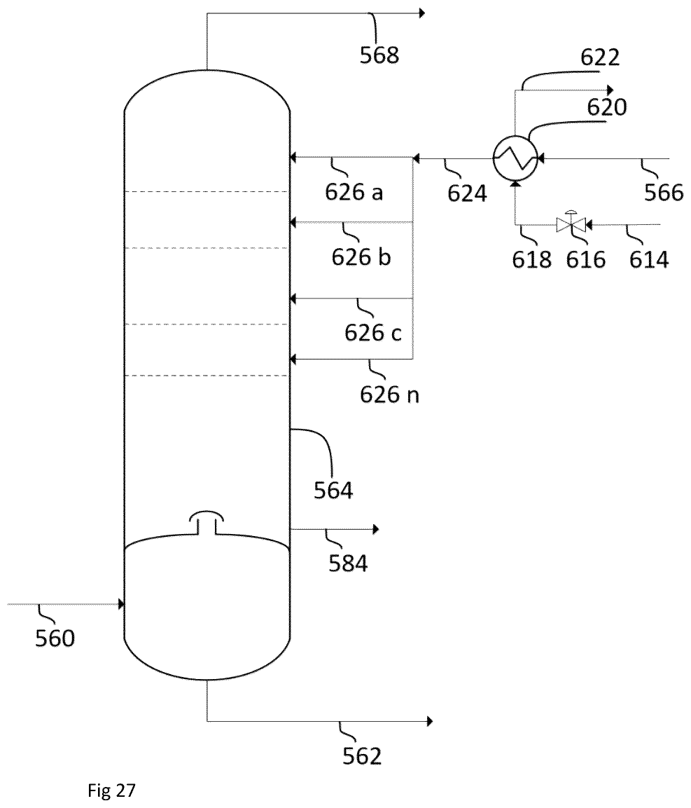

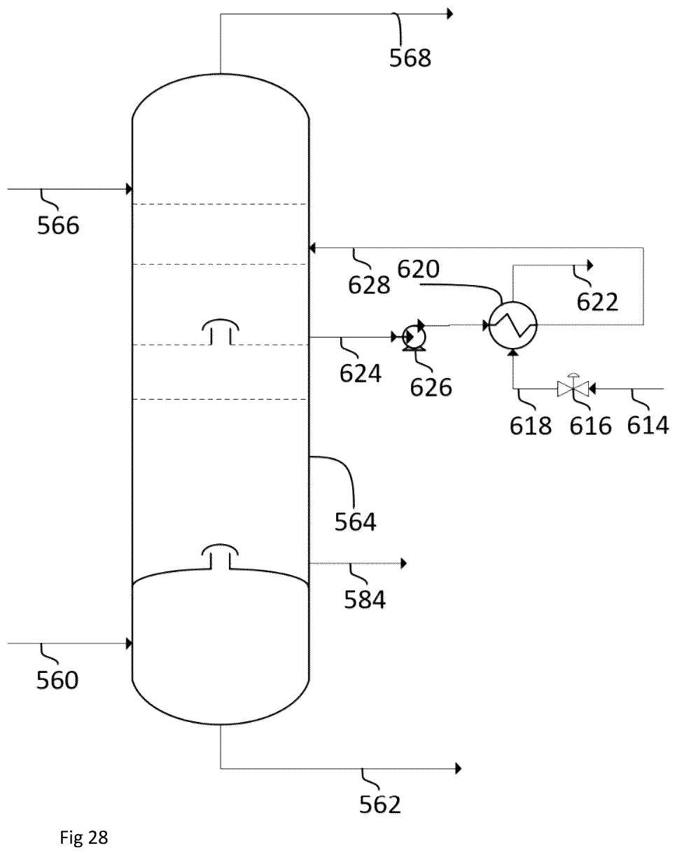

FIGS. 27 and 28 illustrate how the addition of a cooling device, that uses the expanded acid gas, could be used to provide supplemental cooling to the absorbing solvent in an absorber contactor. This would provide the means of being able to either selectively cool specific zones of the contactor perhaps to affect the kinetics of a particular reaction of to affect the actual volumetric flow rate of the treated gas to help with contacting stage debottlenecking) or to remove heat associated with a chemical or physical solvent as they remove the solute component(s) from the process streams.

This general approach has been applied to absorber contactors previously. The unique aspect here is as above the ability to utilize the properties of the conditioned/dehydrated acid gas to provide lower temperatures without the need for an external refrigeration unit. There is also the potential to fully realize the benefit of these cold temperatures in many absorption applications since many absorbing solvents have freezing temperatures well below the freezing point of water.

FIG. 27 illustrates a configuration where the lean absorbing solvent 566 is further cooled in heat exchanger 620 by using an expanded conditioned acid gas stream through the circuit 614 to 622 using an expanding device represented in this figure by valve 616.

The total amount of cooling would be designed on a case by case basis to meet the desired properties of the specific analyzed case. It is possible to provide additional operation limits on the temperature of the flashed acid gas based on an online thermodynamics calculation representing the expansion with the conditioned composition in mind to prevent undesired liquid or solid formation.

Once the lean solvent passes through the heat exchanger, it may be injected at one or many points in absorber contactor 564 represented by 626 a-626 n, based on a detailed analysis of the requirements for a specific configuration.

FIG. 28 illustrates a configuration where a pump around stream of absorbing solvent 624 is cooled in heat exchanger 620 using an expanded conditioned acid gas stream through the circuit 614 to 622 using an expanding device represented in this figure by valve 616. The total amount of cooling would be designed on a case by case basis to meet the desired properties of the specific analyzed case. It is possible to provide additional operation limits on the temperature of the flashed acid gas based on an online thermodynamics calculation representing the expansion with the conditioned composition in mind to prevent undesired liquid or solid formation.

Once the pump around liquid passes through the heat exchanger it may be 628 injected at the desired point contactor 564, the configuration of which would be determined with detailed analysis of the requirements for a specific case.

FIG. 29 illustrates the addition of the cooling device 634 potentially comprising multiple circuits 644 and 646 the vapor space of the reboiler 633 of the TEG regenerator 632 for the purpose of selectively removing water from the system in stream 636. This would result in a lower partial pressure of water in the vapor space and would provide the ability to further regenerate the TEG solution, which would have a significant impact on reducing circulation rates, emission and energy utilization of the overall TEG system.

The application of a cooling device in the vapor space has been documented previously. This built on the use of a colder heat medium as well as the potential to use multiple circuits within the cooling device configuration to allow for ability to have a deeper removal of the condensable components with additional cooling and condensation/freezing.

In general, the cooling device as mentioned in FIGS. 23 through 29 could be utilized in numerous ways to enhance existing processes and to be able to capture condensable components in a flexible way that may otherwise not have a practical means of recovery or require an additional treatment processing.

We claim:

1. A method for optimizing an acid gas dehydration circuit, comprising:
analyzing the overall efficiencies of the pre-existing unit operations attributed to said acid gas dehydration circuit;
selecting further unit operations for implementation into the analyzed acid gas dehydration circuit;
determining at least one of location, duration and sequencing parameters of selected unit operations for implementation in said analyzed acid gas dehydration circuit;
implementing said selected unit operations and said parameters in the analyzed circuit to provide a modified circuit; and
operating said modified circuit where at least one of the modified circuit and selected operations is optimized relative to said analyzed circuit.

2. The method as set forth in claim 1, further including the step of selectively operating at least one of said pre-existing unit operations and said selected unit operations at above or below prescribed pre-implemented characteristic operating standards.

3. The method as set forth in claim 2, further including the step of selectively operating at least one of said pre-existing unit operations and said selected unit operations at above or below prescribed characteristic operating standards for a predetermined time.

4. The method as set forth in claim 1, further including the step of removing a pre-existing unit operation from an analyzed circuit.

5. The method as set forth in claim 1, further including the step of repositioning a pre-existing unit operation in an analyzed circuit.

6. The method as set forth in claim 1, further including the step of dividing at least one selected unit operation of said pre-existing unit operations and further unit operations into a plurality of subdivided unit operations.

7. The method as set forth in claim 6, further including the step of at least one of pulsing and sequencing said subdivided unit operations in a predetermined time sequence.

8. The method as set forth in claim 1, further including the step of dynamically assessing at least one of utilization and parameters of said selected unit operations during operation of said modified circuit.

9. The method as set forth in claim 8, wherein assessment is automatic.

10. The method as set forth in claim 9, further including the step of utilizing acquired information from said assessment for automatic modification of an underperforming unit operation or process anomalies in said modified circuit.

11. An integrated dehydration method, comprising:
a cooling stream synthesis stage including:
condensing liquids from a preliminary feed stream to form a gas stream;
compressing and cooling said gas stream to form a high pressure stream;
expanding at least a portion of said high pressure stream to form a cooled low pressure synthesized stream;
mixing the cooled low pressure synthesized stream with further initial feed stream to augment cooling and condensation of condensable components present in said further initial feed stream;
a treatment stage including:
contacting an initial feed stream to be dehydrated with a dehydration protocol having a specific sequence of unit operations;
introducing said synthesized stream from said cooling stream synthesis stage at a predetermined location in said dehydration protocol for contact with said initial feed stream associated with the dehydration protocol; and
reducing at least one of the number of unit operations, chemical use and consumption, equipment and size thereof and energy requirement relative to a treatment stage absent the use of said synthesized stream.

12. The method as set forth in claim 11, wherein said synthesized stream is introduced before, during, after and combinations thereof of onset of said dehydration protocol.

13. The method as set forth in claim 11, further including the step of modifying the duration of treatment with said synthesized stream in said dehydration protocol.

14. The method as set forth in claim 11, further including varying the location of treatment with said synthesized stream within said dehydration protocol.

15. The method as set forth in claim 11, further including the step of sequencing contact of said synthesized stream with unit operations of said dehydration protocol.

16. The method as set forth in claim 11, further including the step of varying flow rate of said synthesized stream.

17. The method as set forth in claim 11, further including the step of dividing unit operations of said dehydration protocol into a plurality of unit operations.

18. The method as set forth in claim 11, further including the step of dividing said synthesized stream into a plurality of streams for contact with a stream being processed in said dehydration protocol.

19. The method as set forth in claim 11, wherein said dehydration protocol is selected from the group consisting of solid desiccant adsorption, liquid desiccant absorption, refrigeration, membrane separation, dry gas stripping and combinations thereof.

20. The method as set forth in claim 11, further including the step modulating at least one of said streams for contact with a stream being processed in said dehydration protocol through residency duration, recirculation, quiescence, turbulent flow, counter current flow, aerosol synthesis of said at least one of said streams, spray synthesis of said at least one of said streams and combinations of a plurality thereof.

21. The method as set forth in claim 11, further including the step of selectively operating at least one of said unit operations at above or below prescribed characteristic operating standards attributed to non-integrated unit operations.

22. A processing method, comprising:
providing a fluid stream to be treated;
treating said stream to a first processing circuit to dehydrate and/or recover any condensable material present in said stream;
recovering chemical, mechanical and/or thermal production attributes resulting from said treating of said stream;
feeding the treated stream to a second processing circuit composed of a plurality of unit operations;
utilizing at least one of said attributes at a predetermined location in said second processing circuit;
optimizing the efficiency of a unit operation associated with said predetermined location through interaction with at least one of said attributes, optimization being relative to a unit operation absent said interaction; and
forming a processed stream from said second circuit with predetermined properties.

23. The method as set forth in claim 22, wherein said fluid stream is at least one of a gas stream, a liquid stream and a combination thereof.

24. The method as set forth in claim 22, further including the step of selectively operating at least one of said unit operations at above or below prescribed characteristic operating standards attributed to said unit operations standing alone outside of said method.

25. A method for synergizing fluid processing circuits, comprising:
treating a feed stream in a first fluid processing circuit configured to dehydrate said feed stream;
recovering at least one of chemical, mechanical and thermal attributes resulting from treating said leed stream;
selecting a second fluid processing circuit for synergized combination with said first fluid processing circuit;
analyzing at least one of individual unit operations efficiency and circuit efficiency in at least one of said first fluid processing circuit and said second fluid processing circuit; and
utilizing at least one of the recovered attributes in a predetermined location in said second fluid processing circuit for at least one of:
selectively recovering components present in a feed stream to be treated in said second fluid processing circuit stream otherwise not recoverable in the absence of attribute utilization;
optimizing individual unit operations efficiency in said second fluid processing circuit;
optimizing complete second fluid processing circuit efficiency; and
combinations thereof.

26. The method as set forth in claim 25, further including the step of utilizing a third fluid processing circuit.

27. The method as set forth in claim 25, further including the step of recovering components in said feed stream in said first fluid processing circuit.

28. The method as set forth in claim 25, further including the step of recovering attributes from the treated feed stream treated in said first fluid processing circuit.

29. The method as set forth in claim 25, wherein said components include water, condensables, non-condensables and CO₂.
